(19) United States
(12) Patent Application Publication
(10) Pub. No.: US 2021/0182663 A1
(43) Pub. Date: Jun. 17, 2021

(54) METHODS AND SYSTEMS FOR DEFINING EMOTIONAL MACHINES

(71) Applicant: Sony Interactive Entertainment LLC, San Mateo, CA (US)

(72) Inventor: Albhy Galuten, Santa Monica, CA (US)

(21) Appl. No.: 16/718,071

(22) Filed: Dec. 17, 2019

(51) Int. Cl. G06N 3/08

(52) U.S. Cl. CPC G06N 3/08

(57) ABSTRACT

A method for training an intelligent agent is disclosed comprising creating a personality matrix, combining a cognitive bias matrix with the personality matrix and generating a behavioral function for a situation based on the combined cognitive bias matrix and personality matrix.

### FIELD OF THE INVENTION

Aspects of the present disclosure are related to expert systems, specifically aspects of the present disclosure relate to development of expert systems and machine learning using psychological and sociological information for greater behavioral replication.

### BACKGROUND OF THE INVENTION

The Intelligent Systems, meaning machines and network services working together, can have greater ability to capture remember and compare aural, visual and other sensual cues than humans.

Starting with sight, camera technology has improved to the level where an Intelligent System (IS) could see everything a human could and much more—behind, above, below, at long distances, in virtually no light and in frequency ranges like infrared and ultraviolet light, which are invisible to the human eye but can be detected by some animals. In fact, an IS could see other electromagnetic waves like X-rays, microwaves and radio waves. In order to understand what a human would be seeing the IS would know the limitations of human sight and consider what they would be seeing if they were human, but the other data is available if wanted, creating superhuman sight (and superhuman memory and accuracy of what was seen).

As regards hearing, high resolution binaural recording already mimics very closely what humans hear but why stop there? Systems are in development that can separate individual sounds or stems from performances which will enable an IS to make observations about individual elements of the aural environment.

What about taste and smell? “Since 1982, research has been conducted to develop technologies, commonly referred to as electronic noses that could detect and recognize odors and flavors.” Since then, work has advanced significantly with a better understand of how olfactory recognition works with Andreas Mershin and Shuguang Zhang from MIT winning a DARPA prize with their Nano-Nose.

The ability to identify objects by touch is one of the core functions of human sensing. The BioTac tactile sensor has “the ability to discriminate and identify objects based on their compliance, texture and thermal properties, with performance as well as—and sometimes even better than—human perception.”

Yilun Wang, Michal Kosinski from the Stanford School conducted a study in 2017, which demonstrated the ability of deep neural networks to detect, with a higher degree of accuracy than a control group of humans, sexual orientation from facial images.

Some systems can now read emotions and behavioral cues with more accuracy than can humans. Scientists from the Affective Computing lab at the Massachusetts Institute of Technology have begun to market “artificial emotional intelligence” which evolved from Emotion Facial Action Coding System (EMFACS) that Paul Ekman and Wallace V Friesen and developed during the 1980s but has been taken much further.

It is in this context that aspects of the present disclosure arise.

### BRIEF DESCRIPTION OF THE DRAWINGS

The teachings of the present invention can be readily understood by considering the following detailed description in conjunction with the accompanying drawings, in which:

FIG. 1 is a diagrammatic overview of the components of an IS according to aspects of the present disclosure.

FIG. 2 is diagram view of human behavior as a series of layers according to aspects of the present disclosure.

FIG. 3 is a block diagram depicting Meyers Briggs Personality Typing continuum according to aspects of the present disclosure.

FIG. 4 is a diagram view of the Big Five Personality Traits according to aspects of the present disclosure.

FIG. 5 is a block diagram depicting the Situational Baseline and the Sense Inputs and Outputs according to aspects of the present disclosure.

FIG. 6 is a diagrammatic view of parameters of the Development Filter according to aspects of the present disclosure.

FIG. 7 is an illustrative view of the elements of a Relationship Filter according to aspects of the present disclosure.

FIG. 8 is an illustrative view of elements of the Behavioral Masks according to aspects of the present disclosure.

FIG. 9 is an illustrative view of a mental stack including Behavioral Functions according to aspects of the present disclosure.

FIG. 10 is a diagram depicting detailing elements of the Behavioral Functions according to aspects of the present disclosure.

FIG. 11 is a block diagram showing a complete stack from DNA up through Observed Functions Based on Behavior according to aspects of the present disclosure.

FIG. 12 is a diagram showing connection between Baseline Personae and Individual Instances of Intelligent Systems according to aspects of the present disclosure.

FIG. 13 is a block diagram depicting mapping of Behavioral Biases to the various Filters and Masks according to aspects of the present disclosure.

FIG. 14 is a diagram showing how an Expert System is used to map Behavioral or Cognitive Biases according to aspects of the present disclosure.

FIG. 15 is a block diagram depicting layers that make up the Personality Baseline according to aspects of the present disclosure.

FIG. 16 is a table showing MBTI weighting according to aspects of the present disclosure.

FIG. 17 is a block diagram depicting Cultural Layers according to aspects of the present disclosure.

FIG. 18 is a block diagram showing Behavior Collection according to aspects of the present disclosure.

FIG. 19 is a block diagram depicting how a Situational Baseline is mapped against the Behavioral Biases to create a set of Situational Biases according to aspects of the present disclosure.

FIG. 20 is a block diagram showing mapping of psychological parameters to Behavioral Biases giving a weighting to each according to aspects of the present disclosure.

FIG. 21 is a table showing an example of a behavioral bias matrix makeup for an IS Instance to the situation according to aspects of the present disclosure.

FIG. 22 is a block diagram depicting Imputing Biases to Situational Environments for each IS according to aspects of the present disclosure.

FIG. 23 is a table showing example of a personality matrix according to aspects of the present disclosure.

FIG. 24 is a table showing an alternative view of the baseline personality matrices according to aspects of the present disclosure.

FIG. 25 is a block diagram depicting capturing and analyzing behavioral data according to aspects of the present disclosure.

FIG. 26 is block diagram showing a view of a Social Taxonomy according to aspects of the present disclosure.

FIG. 27 is table view of the parameters that comprise the Full Personality matrix according to aspects of the present disclosure.

FIG. 28 is an unlabeled matrix view of a Matrix used to describe the Personalities according to aspects of the present disclosure.

FIG. 29A is a simplified node diagram of a recurrent neural network for use in an Intelligent system according to aspects of the present disclosure.

FIG. 29B is a simplified node diagram of an unfolded recurrent neural network for use an Intelligent System according to aspects of the present disclosure.

FIG. 29C is a simplified diagram of a convolutional neural network for use in an Intelligent System according to aspects of the present disclosure.

FIG. 29D is a block diagram of a method for training a neural network in development of an Intelligent System to aspects of the present disclosure.

FIG. 30 is a block diagram depicting the training of a Generative Adversarial Neural Network in an Intelligent System according to aspects of the present disclosure.

FIG. 31 depicts a block diagram of an intelligent agent system according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

### INTRODUCTION

Machines have yet to master the art of human interactions. Though many chat bots have fooled users irregularly, communication with machines is often repetitive logical and distinctly inhuman. Humans typically do not act rationally. We have dozens of cognitive biases. However, these behaviors are “Predictably Irrational”. There is nothing stopping an intelligent machine from acting “irrationally” in the same ways that humans do.

In the field of behavioral economics much research has been done in the areas of Bounded rationality, Prospect theory, Intertemporal choice, Nudge theory, Behavioral finance and Behavioral game theory. As these theories evolve and become more dispositive, there is nothing that stops an intelligent machine from acting in the same way a human would when making economic decisions. Alternatively, there is nothing stopping an IS enhanced human from being less irrational.

Aspects of the present disclosure may be broken down into a number of components which when taken together will provide a complete system for defining and building Intelligent Systems or ISs. Such an IS comprises some or all of: devices, networks, storage, data structures, processing, algorithms, inputs, outputs and various Artificial Intelligence techniques including but not necessarily limited to Deep Neural Networks, Convolutional Neural Networks, Recombinant Neural Networks, Expert Systems Generative Adversarial Networks and Artificial Neural Networks using Training and/or Inference. The goal is to teach ISs—including instances from simple chat bots to complete humanoid robots to act in manners more like humans. Toward that end, we will evaluate human responses, psychological, sociological and physical—and the ways in which Intelligent Systems (ISs) can mimic them.

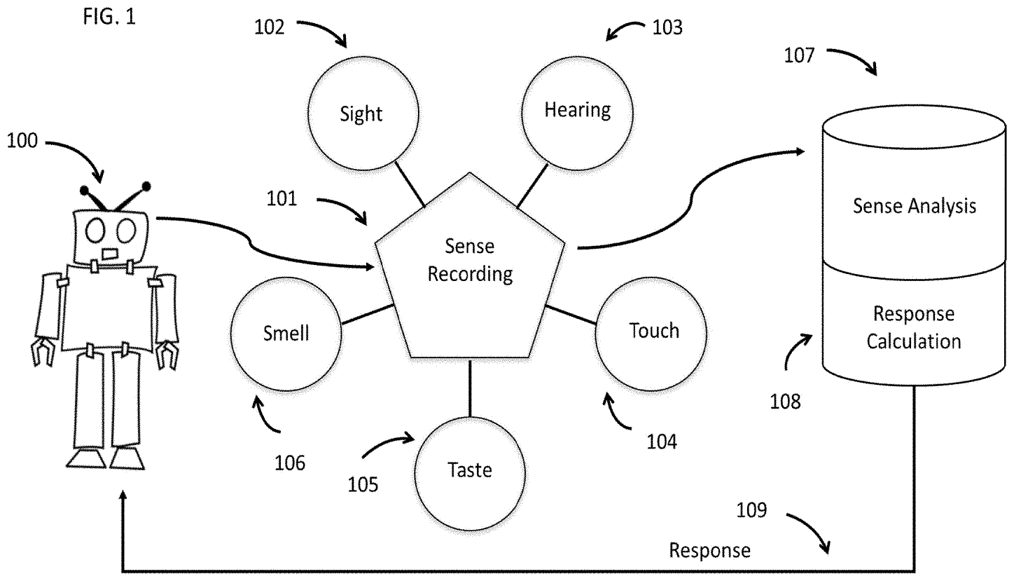

The problem may be broken down into a number of components. Looking at FIG. 1, it can be seen that an IS 100 may record 101 the same inputs that humans have: sight 102, hearing 103, touch 104, taste 105 and smell 106. Next the IS may analyze these inputs—ultimately in near real time—and calculate 108 and, using haptics, speech generation and robotics perform a response 109. The responses constructed by the ISs should be able to mimic human responses in ways indistinguishable from human by other humans and potentially, be even more empathetic (or Machiavellian). Much of this disclosure will address the social and psychological aspects of these understandings and responses. Finally, how can these systems be used to generate virtual environments and react with and in the real world? Let us drill down a bit more on the high-level Architecture.

### Inputs

Looking at the inputs in a bit more detail, Intelligent Systems (meaning machines and network services working together) can have greater ability to capture remember and compare aural, visual and other sensual cues than humans.

### Sight

Starting with sight 102, certainly camera technology has improved to the level where an IS may see everything a human can and in some aspects of the present disclosure much more. Behind, above, below, at long distances, in virtually no light and in frequency ranges like infrared and ultraviolet light, which are invisible to the human eye but can be detected by some animals. In fact, an IS may see other electromagnetic waves like X-rays, microwaves and radio waves (through the use of such sensors). In order to understand what a human would be seeing the IS would be programmed to know the limitations of human sight and consider what they would be seeing if they were human, but the other data is available if wanted, creating superhuman sight (and superhuman memory and accuracy of what was seen). Using machine vision and/or object recognition, an IS may be able to detect and categorize objects in the physical world, including humans, to formulate realistic human responses.

### Hearing

As regards hearing 103, high-resolution binaural recording already very closely mimics what and how humans hear. According to aspects of the present disclosure, an IS may record sound as objects, just as systems like Dolby Atmos play back audio as discrete objects, other systems from companies like General Harmonics, Celemony, Red Pill and Sony are being developed which can capture sound from a stereo or surround field and separate it into individual elements. For example and without limitation an IS or an IS assisted human may listen to a symphony and want to just listen to the first violins or just the French horn and the IS could isolate just those instruments, essentially turning the real world into a recording studio with detailed control (using spectral decomposition methods such as individual component analysis (ICA)). In some embodiments an IS may be integrated into human biology and the human may simply think, while in a concert, “I wish the French horn were a bit louder” and you (or the cyborg component of you) could “change the mix.” With this integration, a person could not only remember everything you have heard but you could listen to it back with a different mix.

### Taste & Smell

Electronic Noses may recognize smells and tastes that humans recognize and also the smells and tastes that other animals, e.g. dogs, recognize. Different humans have different responses to different smells and tastes but it is strictly a Machine Learning data analysis problem to know how I smell versus how you smell (used as a verb). Note that no Qualia are involved, as this is simply a matter of identification. ISs may certainly learn to appreciate the taste and smell of the foods preferred by different cultures or different individuals. In fact, if an IS were to eat (masticate and swallow) food with the appropriate hardware, it could know (or rather store within its memory) the texture as well. It would not necessarily need to digest the food for energy (though that could be designed in). However, a machine could be trained to appreciate (or rather be perceived by outsiders to appreciate) all the subtleties of the appreciation of food and drink as a human or as any particular human. The Jonathan Gold machine with an IS instance could be hired by a restaurant to help judge their menu. Alternatively, a chain of restaurants could dynamically adjust the seasonings based on the tastes of their customers with an IS cook that has appropriate training and hardware.

### Touch

The ability to identify objects by touch is one of the core functions of human sensing. Touch sensors may be used to detect initial contact, contact location, slip, radius of curvature, and edges, as well as determine tri-axial force to enable dexterous handling of objects with unknown properties in unknown locations. Just as with the other senses, for the purposes of this disclosure, we will assume that high resolution touch—both receiving and giving, will become more available as time goes on.

### Behavioral Analysis

The core of this disclosure has to do with the psychological and emotional side of our beings. Humans are pretty good at recognizing emotional states and proclivities in other humans. A person can tell if someone is angry or happy or dozens of other emotions. Analysis of others' emotions and tendencies is based, on what people say but also their reading of body language, facial expression—including micro-expressions, vocal timbre and pitch, scent and physical observations like flushed skin, goose bumps, tears, etc. A person's interpretation of this is somewhat colored by their own experience, preconceptions and expectations. People who are paranoid think others are out to get them but there are many more subtle versions of mapping one person's expectations to another's behavior and to the environment in general. This disclosure will look at how an IS can understand emotions and behavioral tendencies as well as humans or better.

According to aspects of the present disclosure, an IS may take into account the feelings of the person interacting with the IS, e.g., sadness, joy, anger, empathy, or flirtatiousness. Furthermore, an IS according to aspects of the present disclosure may interact with and continuously learn from other inputs, such as television, billboards, sales in showroom windows, price changes, or Crowd behavior.

Before it can respond to emotional inputs, an IS must be able to read and “understand” them. This disclosure is not focused on the primitives of reading emotions. Instead, aspects of the present disclosure gather all of the elements and analyze what they mean about the psychology and sociology of the environment but will assume that other technologies can be used to capture the fundamental primitives.

### Responses

According to aspects of the present disclosure, an IS may exhibit an appropriate response to a given emotional input. Depending on the input and the circumstances surrounding the input, an IS may respond with an emotion, e.g., empathy, anger, disdain, group-think. In some implementations, the IS may respond to the input and circumstances with an action, e.g., a purchase, a sale, or a decision to act, e.g., to clean or to cook. Once intelligent machines are taught to read emotions in physical micro-cues (facial expressions and other body language, smell touch, etc.), intelligent devices (e.g., robots) can be taught to mimic the physical behaviors such as facial expressions, scent, sweat, etc., so that humans can experience their empathy, disdain, etc.

Eating with an IS date. S/he could appreciate the tastes and smells of the foods and respond appropriately—even considering a person's known preferences. At the end of a heavy meal, s/he could act sated, lethargic, drunk, sexually aroused.

Humans typically do not act rationally. We have dozens of cognitive biases. However, these behaviors are “Predictably Irrational”. There is nothing stopping an intelligent machine from acting “irrationally” in the same ways that humans do.

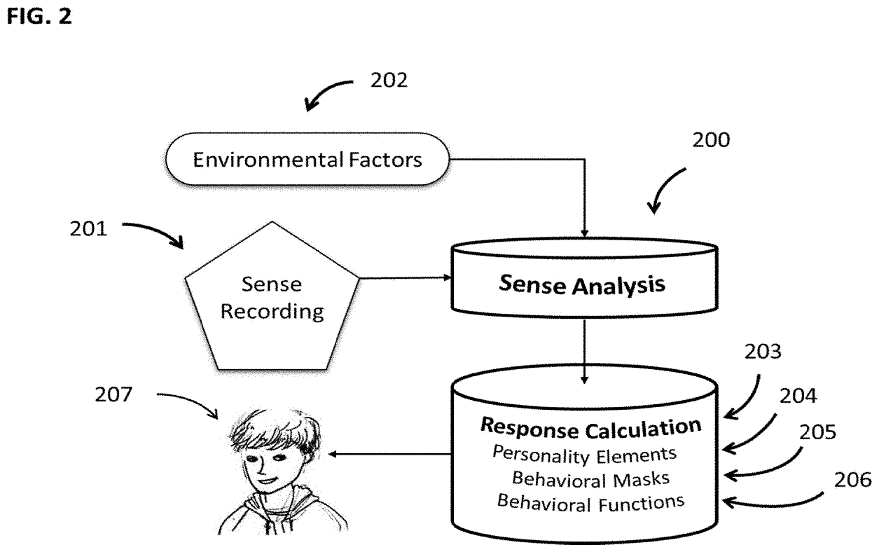

The steps required to make reasonable, even very reasonable and empathetic (or, less ideally, manipulative) responses will be dissected. As shown in FIG. 2, human behavior may be viewed as a series of layers. There are a number of inputs to our Sense Analysis Engine 200. First, there is the Sense Recording 201 as described above. There are also Environmental Factors 202, which will be described more fully later. The other key elements needed to construct the Response Calculation 203 are, Personality Elements 204 that shape our behavior in general. Then Behavioral Masks 205 —, referring to both the mask one wears when we are presenting ourselves to others and also to a mask in computer programming which refers to filtering out various bits or bytes to remove them from the output. After that, Behavioral Functions 206—will be discussed—using functions in the mathematical sense where you have an algorithm or set of operations operating on a set of inputs to create a desired output but applying them to psychological decision making.

### Situational Baseline

The Situational Baseline is the basic personality structure the IS brings into any situation or interaction. There are three components to the Situational Baseline: First is the Basic Personality Type or Personality Elements. In humans, these are mostly the result of genetics and early childhood and often represent the fundamental perspective of humans (e.g. children who were abused, typically never learn to trust). The next developmental layer from the perspective of replicating human response-ability is the Developmental Filter. The Developmental Filter is the cultural and social overlay on top of our basic personality. This is driven by our social and cultural environment, which may include family, community, friends, etc. The third element is the Relationship Filter. These are the filters that act on us based on the context. This reflects the pre-existing relationships to the current place and people.

As used herein, Basic Personality Elements refers to the quantification and analysis of basic human traits. There is undoubtedly a genetic component to these traits and in the future, genetic components will undoubtedly play into the analysis of the Basic Personality Elements. In some embodiments, the basic personality elements are limited to the psychological (and data) approach to basic personality analysis. In alternative embodiments even genetic traits and predispositions are also taken into account, such genetic traits may be applied using a genetic map and a likelihood for certain personality traits due to genetic code markers.

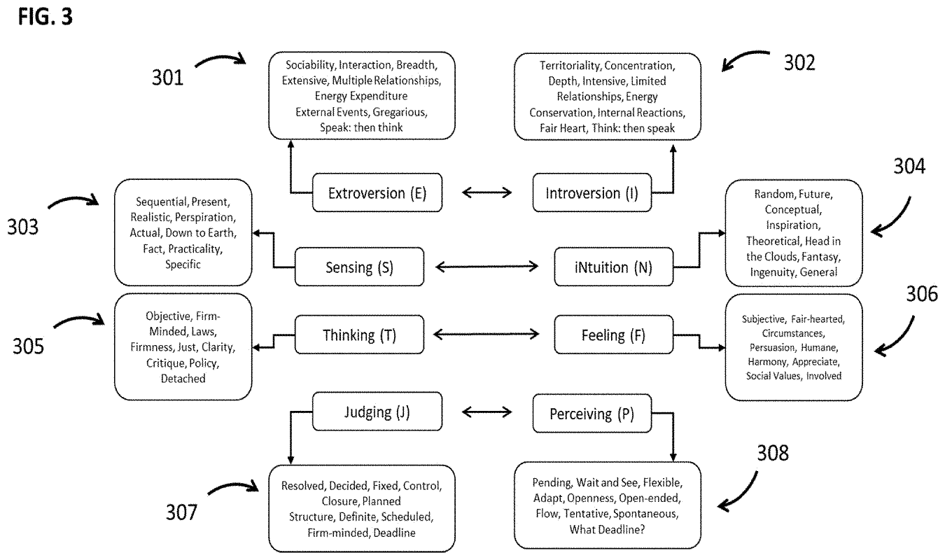

Any personality modeling system in the art may be used for the basic personality elements. For example, and without limitation personality types are typically described in psychological literature using either of two different models. One model is Meyers Briggs Personality Typing, which is based on Jungian architypes and breaks personality into 16 combinations of the binaries as shown in FIG. 3:
Extraversion 301->Introversion 302
Sensing 303->iNtuition 304
Thinking 305->Feeling 306
Judging 307->Perceiving 308

The other common personality analysis tool is the Big Five personality traits or Five Factor modes, originally based on work by Ernest Tupes and Raymond Christal, and later advanced by J. M. Digman and Lewis Goldberg and which is believed by some represent to the basic structure behind all personality traits.

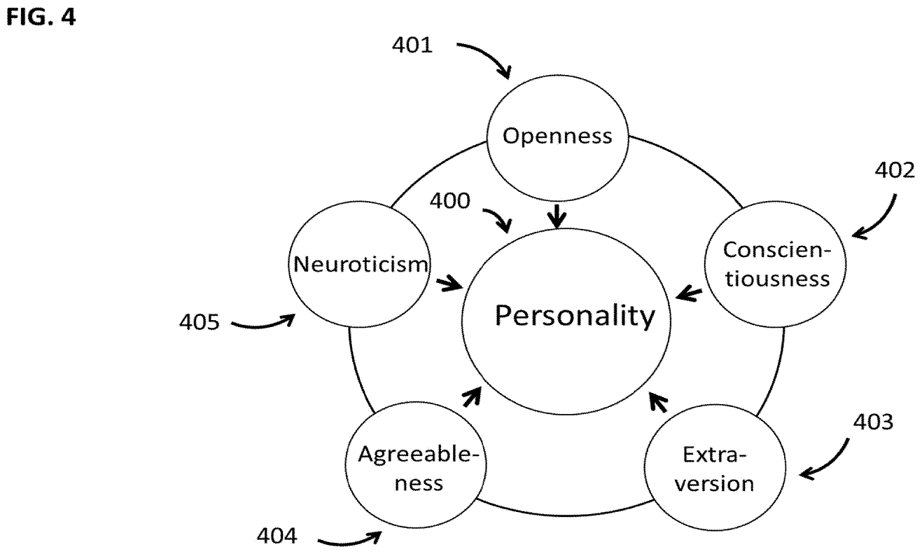

As shown in FIG. 4, the Big Five personality traits 400 are generally described as:
Openness to experience (inventive/curious vs. consistent/cautious) 401
Conscientiousness (efficient/organized vs. easy-going/careless) 402
Extraversion (outgoing/energetic vs. solitary/reserved) 403
Agreeableness (friendly/compassionate vs. challenging/detached) 404
Neuroticism (sensitive/nervous vs. secure/confident) 405

There are numerous other personality continua, including the following traits studies by Personologists. These include, but are not limited to:
Machiavellianism—Refers to individuals who manipulate the behavior of others, often through duplicity. Machiavellians are often interested in money and power, and pragmatically use others in this quest,
Need for Achievement: Those high in need for achievement want to accomplish a lot and set high standards of excellence for themselves. They are able to work persistently and hard for distant goals.
Need for Cognition: People high in need for cognition find it rewarding to understand things and are willing to use considerable cognitive effort in this quest. Such individuals enjoy learning, and the process of trying to understand new things.
Authoritarianism: Authoritarians believe in strict social hierarchies, in which they are totally obedient to those above them and expect complete obedience from their subordinates. Rigid in adherence to rules, the authoritarian personality is very uncomfortable with uncertainty.
Narcissism: The narcissistic personality has self-love that is so strong that it results in high levels of vanity, conceit and selfishness. The narcissistic individual often has problems feeling empathetic toward others or grateful toward others.
Self-esteem: The tendency to evaluate oneself positively. Self-esteem does not imply that one believes that he or she is better than others, only that s/he is a person of worth.
Optimism: The tendency to expect positive outcomes in the future. Optimistic people expect good things to happen and often have more positive outcomes because of it.
Alexithymia: The inability to recognize and label emotions in oneself. These individuals also have difficulty recognizing emotions in others.

To be clear, these personality traits are tendencies. They are not dispositive (or “normative”). Therefore, an ISTJ in Meyers Briggs terminology is perhaps 80% more likely to double-check their shopping cart than an ENFP. These tendencies will affect—at a base level how an IS will react in various social situations. In some embodiments the basic personality of the IS may be set on a continuum along multiple axes using the basic personality elements as axes. For example and without limitation suppose we are creating an IS entity named “Chris?” We may choose its gender and sexual preference as it has an impact on personality but there is more. Using Meyers Briggs as one basic personality approach, we could, for example, decide that Chris is 75% Extravert, 25% Introvert; 43% Sensing, 57%; iNtuition; 27% Thinking, 73% Feeling and 48% Judging, 52% Perceiving. Similar parameters could be used for the Five Factor approach. Chris might be 38% on the Openness to Experience scale, 72% on the Conscientiousness scale, 81% on the Extraversion scale and 22% on the Neuroticism scale. In another embodiment our created personalities may have scales along other continua like Machiavellianism, Need for Achievement, Need for Cognition, Authoritarianism, Narcissism, Self-esteem, Optimism Alexithymia and others known to Personologists or others uncovered as a result of AI analysis of behavior.

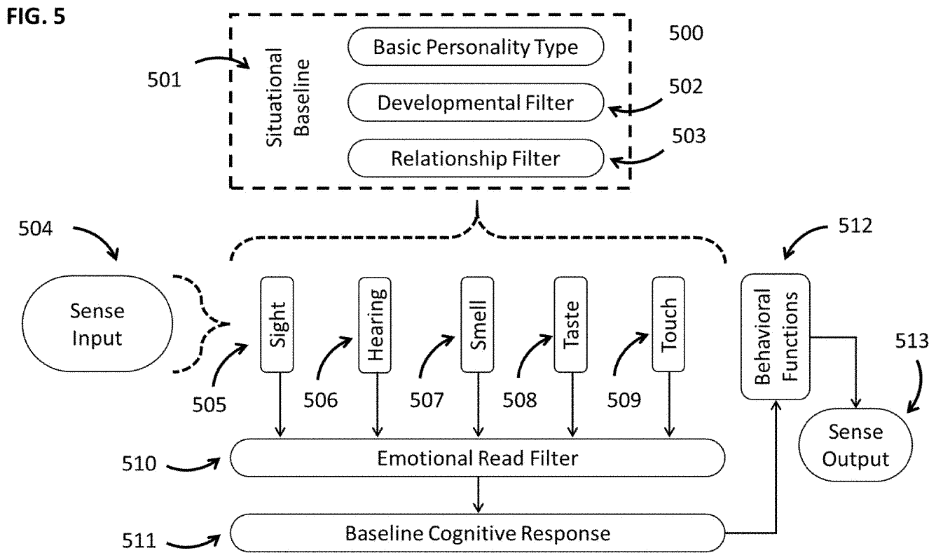

All of this becomes the Basic Personality type 500, which is part of the Situational Baseline 501 as shown in FIG. 5. This complete Situational Baseline 501 is what an IS brings to the relationship in the moment. There are two components beyond the Basic Personality Type. First, the environment in which people are raised affects behavior, the Developmental Filter 502. This includes everything that might have influenced a person's development since birth—relationship to family, the culture in which the person was raised, the political climate, even the weather. People are also affected by their relationship to those people and things around them, the Relationship Filter 503. This includes those the person is speaking with and the person's history with them. For example, the effect of relationships may depend on whether interaction with others takes place in an office, at a resort, in someone's home, etc.

In some implementations, a representation of Personality Type may have 16 Basic Personality Components and having two factors associated with each. Factor 1) is the magnitude of each personality element on the scale up to 100% based on how strongly the IS is on one side or the other, e.g., are they 74% Introverted, 25% narcissistic, 17% Judging, 49% Machiavellian, etc. Factor 2) is the weight of importance of each of the 16 personality components within a given situation, e.g., how important is Narcissism or Thinking or Openness to Experience to the task at hand. Aspects of the present disclosure are not limited to such implementations, however.

This Situational Baseline is then impacted by the Sense Inputs 504 of Sight 505, Hearing 506, Smell 507, Taste 508 and Touch 509. These inputs are then read by the Emotional Read Filter 510 that generated the Baseline Cognitive Response 511. These responses are then fed into the Behavioral Function algorithm 512, which then generates the Sense Output 513.

### Development Filter

According to aspects of the present disclosure the IS may be designed to mimic human behavior, to do so a history for the IS may be created. When screenwriters write scripts, they generally have a “bible” which describes what made the character. Though the script might never refer to where a character was born, knowing whether they were raised on a farm in Iowa or in a Manhattan townhouse greatly influences how the character would act and consequently how the actor will play that character. In the same way, the Developmental Filter is the character bible for the IS. For example, a happy marriage influences one's behavior very differently from being in an unhappy marriage and being in a second marriage that is happy after a first one that was unhappy is different still.

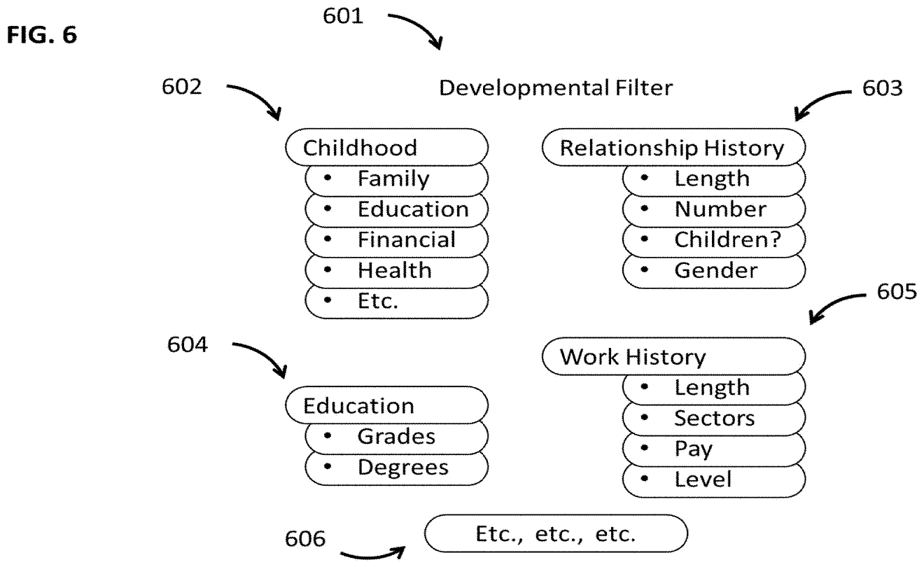

As shown in FIG. 6, the factors that influence the Development Filter 600 may be broken into a few key buckets. The Childhood Development 602 comprises things like Family elements (size, siblings, parents, etc.), Education, Financial Situation, Health, etc. Next is data about the current Relationship History 603, also we can track Educational Data 604, Work History 605 and any number of other factors 606 to be determined as relevant by experts in the field.

According to aspects of the present disclosure, the Intelligent System may be trained using various kinds of artificial intelligence (Deep Learning, Convolutional Neural Networks, Generative Adversarial Networks, etc.) and they can be given the learning of other machines, essentially instantly, so that the depth of understanding will grow exponentially. The interactions between any number of IS may be compared to actual interactions from human history and fine-tuned. Testers may choose other personalities for the IS and run them to see the performance differences. It should be noted that a totally accurate representation of all humans is not needed, a few documented human interaction histories may be sufficient.

### Relationship Filter

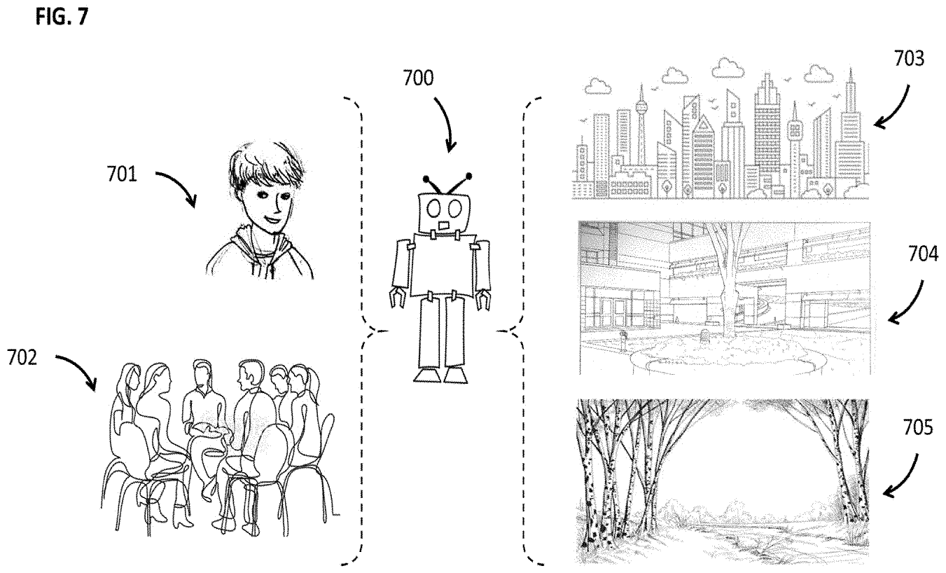

Next, as shown in FIG. 7, is the relationship of our IS 700 to the person 701 or people 702 and the place 703, 704, 705 with whom it is interacting. There has been a lot of psychological analysis in this space. According to aspects of the present disclosure, a corpus of technical relationship data may be generated from psychological surveys. The psychological surveys will answer questions such as, for example and without limitation: How does a person feel when relating to as boss as opposed to relating to a subordinate (this will be impacted by basic personality type—are they someone who stands on protocol or are they someone who is egalitarian)? What about other family members? How does a person feel about genetics (e.g. a relative who they never grew up with but just met)? What about the environment? Are they most comfortable in an office setting or are they more relaxed in a bar or in someone's home? Do they feel superior or smug if the person they are speaking with is short, or someone who is fat? Do they give good eye contact? How sensitive are they to physical cues? How about noise in the environment? In some implementations, the surveys may include a question asking the survey taker to define a weight and magnitude for how they feel about each issue. In other embodiments a weight and magnitude is developed statistically from a collection of psychological surveys answered by humans.

### Behavioral Masks

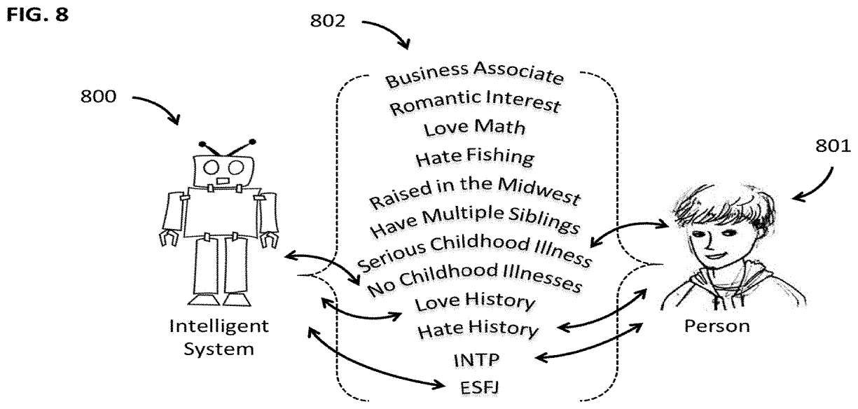

In any behavioral response, there are a limitless number of responses. In the same situation, different people will react differently. Some of the possible areas of impact are shown in FIG. 8. The IS 301 has a relationship with the person 802 that includes things like Business Association, Romantic Attraction, love of intellectual interests or hobbies, where they were raised, what was their family environment growing up, what is their health history, relationship history, what is their psychological type and tendencies?

Any particular IS should be designed to mask out certain responses. Although an IS should be designed to mask out violence except in cases of the protection of others or perhaps in self-defense but still without causing harm. These Relationship Filters or Behavioral Masks are generalized tendencies based on their life history and are overarching based on their background and genetics. Some background might be recent and some might be older and further below the surface, more fundamental.

### Behavioral Functions

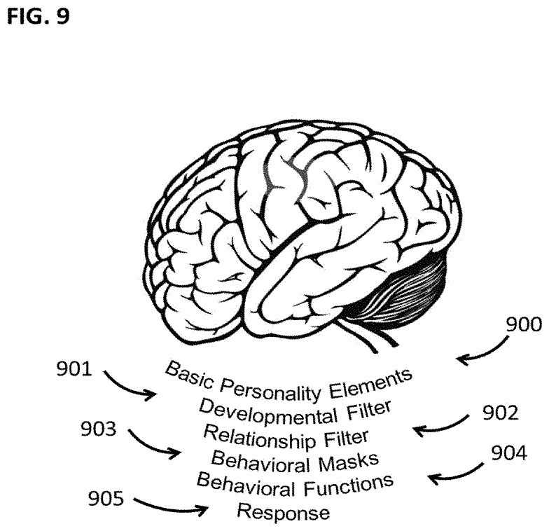

Here, as shown at a high level in FIG. 9, is where we take the preceding layers; Basic Personality Elements 900, Developmental Filter 901, Relationship Filter 902 and Behavioral Masks 903 and use them as operators for the task Response 905 at hand. The task could be for example and without limitation; responding to a question in a conversation, looking at someone who just said something, deciding whether to purchase an item or not, choosing another restaurant or time or date if the first choice is not available, offering an alternative to a shopper or, basically any response a human might make today. One key question is, “How human do we want the response to be?” Humans are not rational actors and according to aspects of the present disclosure an IS may be configured to mimic irrationality. For example, and without limitation, suppose someone is upset but there is nothing that can be done about it. Perhaps the person just missed a plane and now cannot get be at a wedding on time. A rational actor might say, there is nothing that can be done about it, all options have been investigated and the best thing to do is to send an apology text. However, a human actor might say, “Oh my God, what a bummer! Let's see if we can think of some way to help. First let me see if there is another way that will get you there in time.” After an appropriate pause and more commiseration, they might say “Do you think they would prefer if you showed up the next morning to say goodbye as they leave for their honeymoon or just sent a note or a text?” The point is that humans care as much about the process as they do about the result. Thus, an IS may be designed to mimic human responses by providing appropriate behavioral function layer 904 parameters to that provide a process awareness.

As another example, suppose one is pricing watches in a store. Humans are subject to a Cognitive Bias known as “anchoring”. As an example, if one item is priced very high it makes the others seem more reasonable even though they are actually still expensive. An IS with appropriate masks or filters in the behavior function layer 904 may be developed to respond with human biases as will be discussed below.

Humans are filled with Cognitive Biases that are part of what makes them human. Humans believe that they rationally analyze all factors before making a choice or determining value but the truth is that a first perception lingers in the mind, affecting future perceptions and decisions. Another Cognitive Bias is “confabulation”. People believe they know when they are lying to themselves but they are unaware of the constant nudging we receive from ideas formed in our unconscious mind. Behavioral psychology is filled with studies that have demonstrated at least the following named biases:

Priming, Confabulation, Hindsight Bias, Texas Sharpshooter Fallacy, Procrastination, Normalcy Bias, Introspection, Availability Heuristic, Bystander Effect, Dunning-Kruger Effect, Apophenia, Brand Loyalty, Argument from Authority, Argument from Ignorance, Straw Man Fallacy, Ad Hominem Fallacy, Just-World Fallacy, Public Goods Game, Ultimatum Game, Subjective Validation, Cult Indoctrination, Groupthink, Affect Heuristic, Dunbar's Number, Selling Out, Self-Serving Bias, Spotlight Effect, Third Person Effect, Catharsis, Conformity, Extinction Burst, Supernormal Releasers, Fundamental Attribution Error, Representativeness Heuristic, Social Loafing, Learned Helplessness, Anchoring Effect, Self-Fulfilling Prophecies, Moment, Illusion of Control, Consistency Bias, and Expectation.

A few brief examples without limitation should suffice to demonstrate how this will work in general. Let us take the example of the Dunning Kruger effect. The Dunning Kruger effect is a cognitive bias in which people mistakenly assess their cognitive ability as greater than it is. It is related to the cognitive bias of illusory superiority and comes from the inability of people to recognize their lack of ability. For an IS designed as a learning aide adding a cognitive bias such as the Dunning Kruger effects makes the IS more relatable to the user and may make learning more entertaining. Suppose for example a person is learning to program in JavaScript and there is an expert programmer who can answer all their questions. However, this is not entertaining since of the joy of learning anything (including programming) comes from shared discovery. An IS with the Dunning Kruger effect bias would share the person's naïve enthusiasm. This would be true for any task. By way of example, and not by way of limitation, consider learning basketball. It would be less fun to either a) play with someone who always made every basket or b) someone who was painfully aware of their shortcomings. It is more interesting to have a little human encouragement and shared naïve belief in developing capabilities rather than a machine that can coldly calculate your actual chances of making that free throw or slam-dunk.

Hindsight bias refers to the tendency for people to perceive events that have already occurred as having been more predictable than they actually were before the events took place. In this case, the IS, with perfect memory and perception, would know exactly how often it had correctly predicted an event, say that the weather was going to turn foul. Of course, humans make predictions based on feeling the temperature change, perhaps the barometric pressure (“my arthritis is acting up”), etc. A person who predicts that it will rain tomorrow and it doesn't rain forgets having made the prediction but if it does rain, remember and says, “I knew it!”

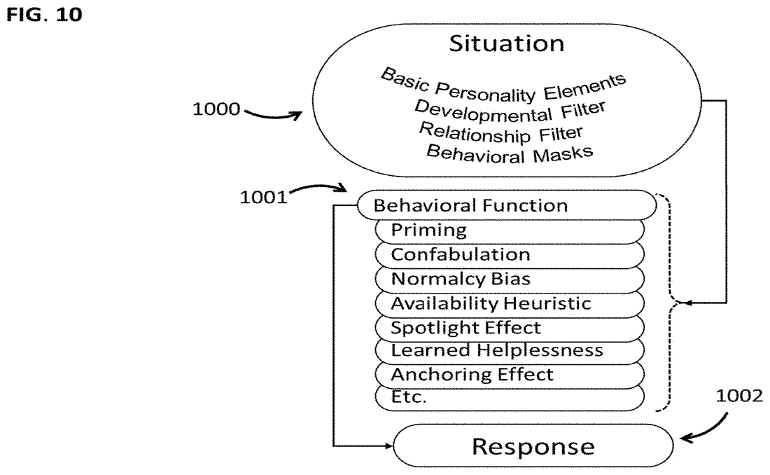

FIG. 10 illustrates the whole stack to this point. Situation 1000 is made of a Situational Baseline (Basic Personality Elements, Developmental Filter and Relationship Filter), plus Behavioral Masks and these are filtered through Behavioral Functions 1001, such as Priming, Confabulation, Normalcy Bias, etc. and craft a response 1002.

An IS may makes decisions as follows. Cognitive bias may be described as a function, for example: Behavior f(HindsightBias)=(programmed degree of experience on axis #1) (programmed degree of experience on axis #2 to n) (inherent predictability of event on each axis). For example, for a sailor a programmed degree of experience relates to the sailor's experience on an axis of weather at the seaside or the sailor's experience of weather prediction in the desert. From an IS system perspective, the IS has been primed by the “Situation”—meaning its Basic Personality Elements (Myers Briggs, Genetic makeup, Gender, etc.) Modified by the Development Filter (cultural and social upbringing), then contextualized by the Relationship Filter (long-term relationship to the people and environment) further modified by the Behavioral Masks (what is my current relationship to the people involved, social hierarchy, etc.). This created the basic context on which the function, e.g. Behavior f(HindsightBias) acts.

In discussing Intelligent Systems within the context of the present disclosure, it makes more sense to call cognitive biases, Behavioral Biases. Training an IS to mimic these behavioral biases will be discussed in a later section.

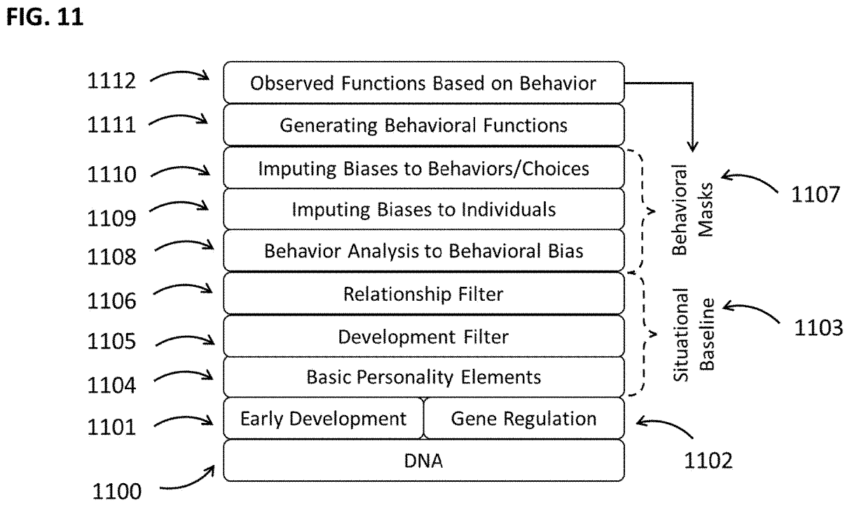

Before we examine how we will use Machine Learning to train the IS, it is useful to take a high-level look at the complete stack as shown in FIG. 11. The lowest level input to our behavior is DNA 1100. How DNA affects personality will depend on a number of factors generated specifically for the IS or factors that associated with a person an IS modeled after. Right above DNA 1100 is how the IS is patterned based on early development 1101. Things that happen in early development (abuses, extreme poverty, total love, etc.) shape people very deeply and usually permanently and will have an effect on the IS's personality as well. In the same timeframe (and continuing to a lesser degree) is Gene Regulation 1102, which controls behavior with a combination of genetic and environmental factors. Above that are the elements that make up the Situational Baseline 1103—composed first of the Basic Personality Elements 1104, followed by the Development Filter 1105 and the Relationship Filter 1106. Climbing still further up the stack are the Behavioral Masks 1107 that analyze the behavioral biases 1108 and impute those biases to individuals 1109 and environments or behaviors and choices 1110. From all of this data Behavioral Functions 1111 can be used to create the behavior. After this, the results of the interactions based on the functions are fed back into the Behavioral Masks as the system keeps learning from its experience.

### Personae

Each ISI has a growth or development path. This path has a number of key points but one point is the point at which they become non-fungible—that is when they interact with a human for the first time. For example, and without limitation suppose we consider a personal (concierge) customer care representative, an IS called Dale. Dale knows an individual customer's complete customer care history across all of the customer's devices by any manufacturer. Dale has a personality developed up through the Situational Baseline. A customer could choose from a number of Situational Baselines or could have one chosen for them based on a personality profile. Now, going forward and based on the customer's interactions with the IS, their personality will develop. One year after, Dale will know what the customer finds funny, whether the customer likes to chat or just get straight to business and of course all of the customer's purchase and support history. This is a persona just for that individual customer. If another human customer starts with a representative having the same Situational Baseline, that customer's instance of the “Dale” IS will not stay the same for long. As the IS interacts with this customer, the relationship will develop differently from Dale's relationship with the first customer. For the purposes of the present disclosure, personae developed up through the Situational Baseline (or our virgin personalities) are referred to herein as Baseline Personae and each persona “customized by human interaction” is an ISI (Intelligent System Instance). If two customers get married and share all of their devices and their personal customer care contract that does not mean that they have to share the support persona. One spouse's support persona will still be Dale and the other spouse's will still be Alex (the support persona for the other spouse prior to the two spouses meeting each other) but Dale and Alex will both have access to all of the collective device history for the two spouses but depending on who calls, either Dale or Alex will be on the other end of the line. Aspects of the present disclosure include implementations in which both spouses are on a conference call with both Dale and Alex all on the phone at once and the personalities would naturally mix. Thus, the IS creates an “enhanced” customer support experience for you and your wife.

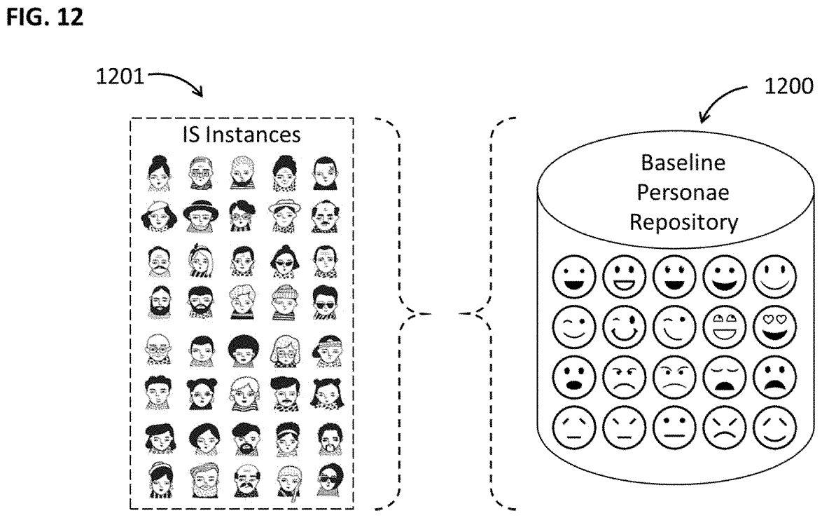

According to aspects of the present disclosure for data management as shown in FIG. 12, there is a repository of Baseline Personae 1200 or the elements to create a Baseline Persona on the fly and, in each new situation an IS Instance 1201 is created from one Baseline Persona. This instance can be stored and updated after each interaction or it can be dynamically recreated whenever it is needed based on the parameters of the previous interactions. In some embodiments the IS Instances are cached for a limited period of time to eliminate latency, but the parameters are stored so that, even if they have been offline for a long period, they can be reconstituted exactly where they left off.

### Training the Intelligent System

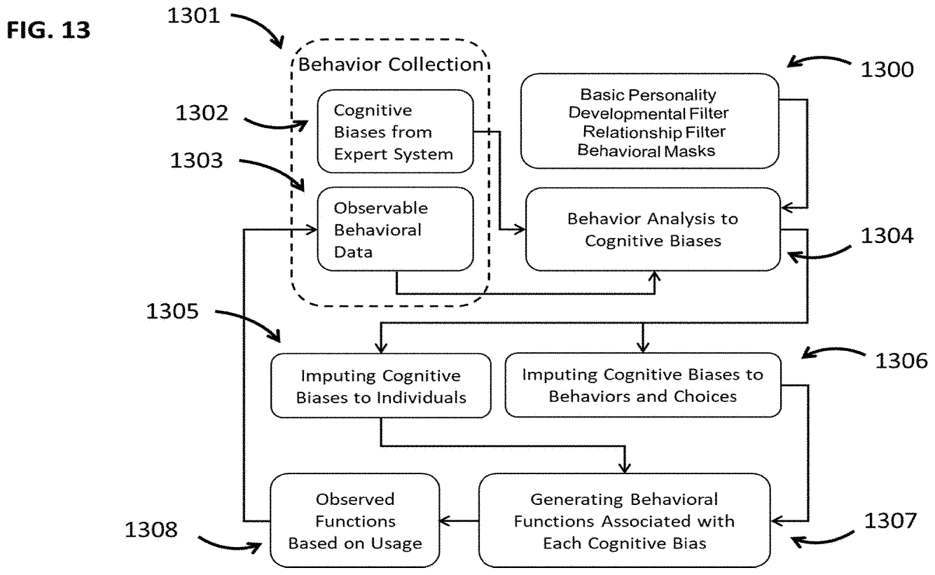

Machine learning (Deep Neural Nets, Machine Learning, CNNs, RNNs, GANs, etc.) may be implemented to capture and categorize these Behavioral Biases and then mimicking them when “acting human.” Looking at FIG. 13, some of the other layers of Basic Personality 1300 have been discussed above The Development Filter, the Relationship Filter and the Behavioral Masks. The next layer in mapping human cognitive behavior is to map the Behavioral Biases. To train the IS to act human, there are a number of steps that may be taken. Behavior Collection 1301 starts with an Expert System built by Psychologists based on the knowledge we have about cognitive biases 1302. This augmented, enhanced and mostly replaced by observable behavioral data 1303 in both the human world and the human/IS virtual world. Observable behavioral data may be generated by observing conversations in the human world, There is an expectation of how a person will react in certain conversational setting based on a model of their cognitive biases and psychological profile and when the reaction is different than the model, the model is updated. In this situation the conversational setting may be a generated through passively observing conversations between humans with known psychologies or actively generated through a conversation between a human and an IS. The IS may provide or discuss topics with the human having a known psychological profile and gauge the response of the human based on predicted responses. The predicted model may be updated based on actual human responses. Next, the Behavior Analysis is mapped to the Cognitive Biases 1304. The resulting Behavioral Biases are used to impute how the IS responds if they are a certain type of individual 1305 (based on all the layers above) and also how those apply to different behaviors and choices 1306. The combination of the individual behavioral expectation 1305 and the environmental choices 1306 are applied as a function to create the behavioral bias 1307 of the IS. The behavior and working of the Functions 1308 may be observed and that learning is fed back into the Observable Behavioral Data 1303. Once instances of an IS are working, they can begin training each other with a GAN (Generative Adversarial Network) to continue evolution.

### General Neural Network Training

According to aspects of the present disclosure the IS system may include one or more of several different types of neural networks and may have many different layers. By way of example and not by way of limitation the classification neural network may consist of one or multiple convolutional neural networks (CNN), recurrent neural networks (RNN) and/or dynamic neural networks (DNN).

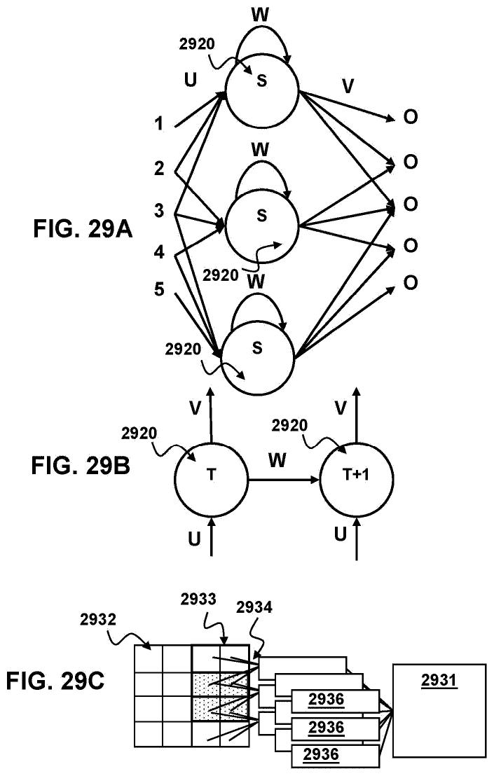

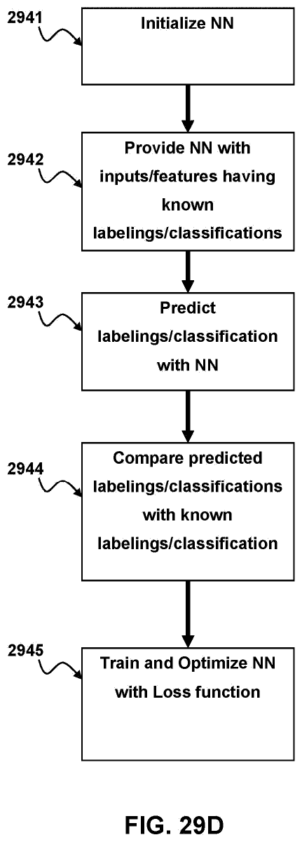

FIG. 29A depicts the basic form of an RNN having a layer of nodes 2920, each of which is characterized by an activation function S, one input weight U, a recurrent hidden node transition weight W, and an output transition weight V. The activation function S may be any non-linear function known in the art and is not limited to the (hyperbolic tangent (tan h) function. For example, the activation function S may be a Sigmoid or ReLu function. Unlike other types of neural networks, RNNs have one set of activation functions and weights for the entire layer. As shown in FIG. 29B the RNN may be considered as a series of nodes 2920 having the same activation function moving through time T and T+1. Thus, the RNN maintains historical information by feeding the result from a previous time T to a current time T+1.

In some embodiments, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9(8):1735-1780 (1997), which is incorporated herein by reference.

FIG. 29C depicts an example layout of a convolution neural network such as a CRNN according to aspects of the present disclosure. In this depiction, the convolution neural network is generated for an input 2932 with a size of 4 units in height and 4 units in width giving a total area of 16 units. The depicted convolutional neural network has a filter 2933 size of 2 units in height and 2 units in width with a skip value of 1 and a channel 2936 of size 9. For clarity in FIG. 2C only the connections 2934 between the first column of channels and their filter windows is depicted. Aspects of the present disclosure, however, are not limited to such implementations. According to aspects of the present disclosure, the convolutional neural network that implements the classification 2929 may have any number of additional neural network node layers 2931 and may include such layer types as additional convolutional layers, fully connected layers, pooling layers, max pooling layers, local contrast normalization layers, etc. of any size.

As seen in FIG. 29D Training a neural network (NN) begins with initialization of the weights of the NN 2941. In general, the initial weights should be distributed randomly. For example, an NN with a tan h activation function should have random values distributed between

$$- \frac{1}{\sqrt{n}} and \frac{1}{\sqrt{n}}$$

and where n is the number of inputs to the node.

After initialization the activation function and optimizer is defined. The NN is then provided with a feature vector or input dataset 2942. Each of the different features vectors may be generated by the NN from inputs that have known labels. Similarly, the NN may be provided with feature vectors that correspond to inputs having known labeling or classification. The NN then predicts a label or classification for the feature or input 2943. The predicted label or class is compared to the known label or class (also known as ground truth) and a loss function measures the total error between the predictions and ground truth over all the training samples 2944. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function and using known methods of training for neural networks such as backpropagation with adaptive gradient descent etc. 2945. In each training epoch, the optimizer tries to choose the model parameters (i.e., weights) that minimize the training loss function (i.e. total error). Data is partitioned into training, validation, and test samples.

During training, the Optimizer minimizes the loss function on the training samples. After each training epoch, the mode is evaluated on the validation sample by computing the validation loss and accuracy. If there is no significant change, training can be stopped and the resulting trained model may be used to predict the labels of the test data.

Thus, the neural network may be trained from inputs having known labels or classifications to identify and classify those inputs. Similarly, a NN may be trained using the described method to generate a feature vector from inputs having a known label or classification.

### Generative Adversarial NN Training

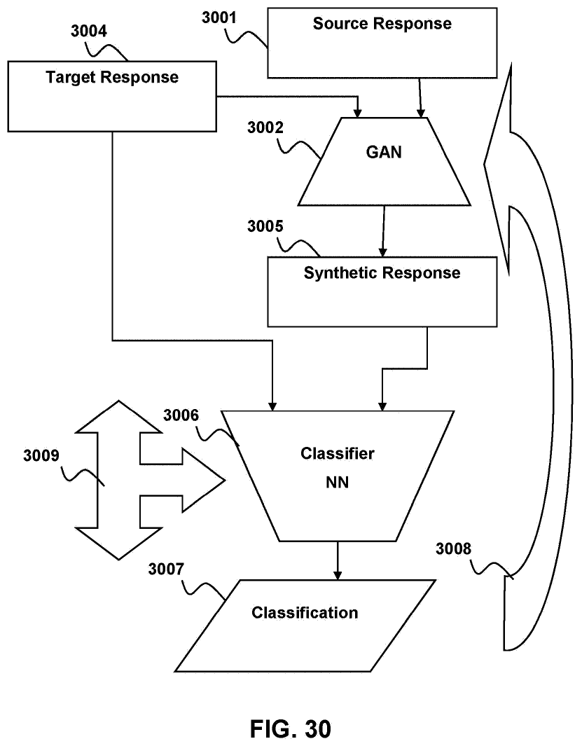

Training a generative adversarial NN (GAN) layout requires two NN, as shown in FIG. 30. The two NN are set in opposition to one another with the first NN 3002 generating a synthetic source Response 3005 from a source Response 3001 and a target Response 3005 and the second NN classifying the responses 3006 as either as a target Response 3004 or not. The First NN 3002 is trained 3008 based on the classification made by the second NN 3006. The second NN 3006 is trained 3009 based on whether the classification correctly identified the target Response 3004. The first NN 3002 hereinafter referred to as the Generative NN or G_{NN} takes input responses (z) and maps them to representation G(z; θ_{g}).

The Second NN 3006 hereinafter referred to as the Discriminative NN or D_{NN}. The D_{NN} takes the unlabeled mapped synthetic source responses 3006 and the unlabeled responses (x) set 3004 and attempts to classify the responses as belonging to the target response set. The output of the D_{NN} is a single scalar representing the probability that the response is from the target response set 3004. The D_{NN} has a data space D(x; θ_{d}) where θ_{d} represents the NN parameters.

The pair of NNs used during training of the generative adversarial NN may be multilayer perceptrons, which are similar to the convolutional network described above but each layer is fully connected. The generative adversarial NN is not limited to multilayer perceptron's and may be organized as a CNN, RNN, or DNN. Additionally the adversarial generative NN may have any number of pooling or softmax layers.

During training, the goal of the G_{NN} 3002 is to minimize the inverse result of the D_{NN}. In other words, the G_{NN} is trained to minimize log(−D(G(z)). Early in training problems may arise where the D_{NN} rejects the mapped input responses with high confidence levels because they are very different from the target response set. As a result the equation log(−D(G(z)) saturates quickly and learning slows. To overcome this initially G may be trained by maximizing log D(G(z)) which provides much stronger gradients early in learning and has the same fixed point of dynamics. Additionally the GAN may be modified to include a cyclic consistency loss function to further improve mapping results as discussed in Zhu et al. “Unpaired Image to Image Translation using Cycle-Consistent Adversarial Networks” ArXiv, ArXiv:1703.10593v5 [cs.CV] available at: https://arxiv.org/pdf/1703.10593.pdf (30 Aug. 2018), which is incorporated herein by reference.

The objective in training the D_{NN} 3006 is to maximize the probability of assigning the correct label to the training data set. The training data set includes both the mapped source responses and the target responses. The D_{NN} provides a scalar value representing the probability that each response in the training data set belongs to the target response set. As such during training, the goal is to maximize log G(x).

Together the First and Second NN form a two-player minimax game with the first NN 3002 attempting generating responses to fool the second NN 3006. The Equation for the game is: min_{G} max_{D} V(D,G)=Eₓ˜_{pdata}(x)[log D(x)]+E_{z}˜_{pz}(z) [log 1−log D(G(z))

The G_{NN} and D_{NN} are trained in stepwise fashion with optimizing the D_{NN} and then optimizing the G_{NN}. This process is repeated numerous times until no further improvement is seen in the discriminator. This occurs when the probability that the training response is a mapped input response, p is equal to the probability that the training response is a source response, p_{data}. In other words when p_{z}=p_{data}, alternatively D(x)=½. Similar to what was discussed above for neural networks in general, the G_{NN} and D_{NN} may be trained using minibatch Stochastic Gradient Descent or any other known method for training compatible neural networks. For more information on training and organization of Adversarial Generative Neural Networks see Goodfellow et al. “Generative Adversarial Nets” arXiv:1406.2661 available at: https://arxiv.org/abs/1406.2661.

### Expert System

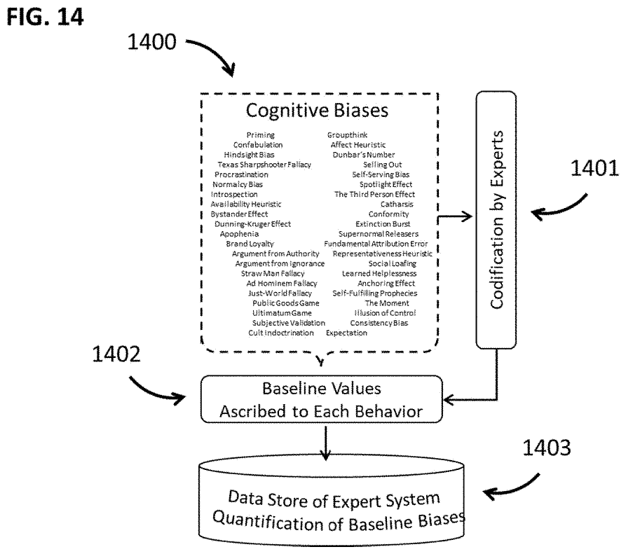

Expert Systems typically use either forward chaining or backward chaining. According to aspects of the present disclosure, some embodiments of the expert system may use forward chaining. Additionally, embodiments of the present disclosure may use Prospect Theory and generate Synthetic Datasets to assist in the development and training of an expert system. AS can be seen in FIG. 14 initially there is a set of Cognitive Biases 1400. Though the field is continuously expanding, there are currently 47 common ones: Priming, Confabulation, Confirmation Bias, Hindsight Bias, The Texas Sharpshooter Fallacy, Procrastination, Normalcy Bias, Introspection, The Availability Heuristic, The Bystander Effect, The Dunning-Kruger Effect, Apophenia, Brand Loyalty, The Argument from Authority, The Argument from Ignorance, The Straw Man Fallacy, The Ad Hominem Fallacy, The Just-World Fallacy, The Public Goods Game, The Ultimatum Game, Subjective Validation, Cult Indoctrination, Groupthink, Supernormal Releasers, The Affect Heuristic, Dunbar's Number, Selling Out, Self-Serving Bias, The Spotlight Effect, The Third Person Effect, Catharsis, The Misinformation Effect, Conformity, Extinction Burst, Social Loafing, The Illusion of Transparency, Learned Helplessness, Embodied Cognition, The Anchoring Effect, Attention, Self-Handicapping, Self-Fulfilling Prophecies, The Moment, Consistency Bias, The Representativeness Heuristic, Expectation, The Illusion of Control and The Fundamental Attribution Error. It should be noted that the above list is provided without limitation as the field of known biases is currently expanding and any number of biases may be added with sufficient programming as known by one of ordinary skill in the art. These biases are confirmed by our Experts 1401. Then (still using our experts) Baseline Value is ascribed to Each Behavior 1402. These Baseline Values are then stored in a Data Store of Expert System Quantification of Baseline Bias 1403. Ultimately, it does not matter if this is completely accurate because the system will learn more from the actual behavior over time but a baseline is necessary to begin the process and to give us a lens through which to see the behaviors.

Development of the expert system begins with determining cognitive bias and mapping them to situational environments and ascribing a baseline value to each behavior 1402. For example, and without limitation: to gain some baseline numbers for Apophenia (the tendency to mistakenly perceive connections and meaning between unrelated things), psychologists look at coincidences (say running into someone you know or finding that people in your class have your same birthday) and list the most common 100 coincidences. Then the psychologist determines from statistical and experimental data a weight of the likelihood of each event against the probable degree of surprise. This statistical and experimental data may be generated through surveys or observation of human subjects. These mappings are baseline mappings—not based at all on the personality of any individual person, just typical expected reactions. The nice thing about Expert Systems is that they are naturally weighted so the outcomes are not limited to binary results. For example, and without limitation, look at meeting someone on vacation from their hometown. Because of social connections, common media, common social behaviors, climate, and vacation scheduling, it may not be that uncommon to run into someone with whom they share common friends, but it is always surprising. For example, at a large resort in Las Vegas, probability might suggest that during Spring Break, this would happen once every 30 social interactions but when queried, people have suggested they would expect it to happen once in 100. Therefore, for this particular case of Apophenia, it would be given an “Over-likelihood Value” of 3.33 (100/30). Some number (perhaps dozens) of Apophenia examples will be collected and a set of Apophenia Baselines for the most common situations are generated from the examples. These are stored with all of our other Behavioral Bias Baseline data. Then, when the Expert system encounters social situations where Apophenia would be applied for a human, the Expert System applies the appropriate baseline to the situation. We can use a similar approach defining our Expert System Baseline for each Behavioral Bias.

### Creating the Baseline Personality

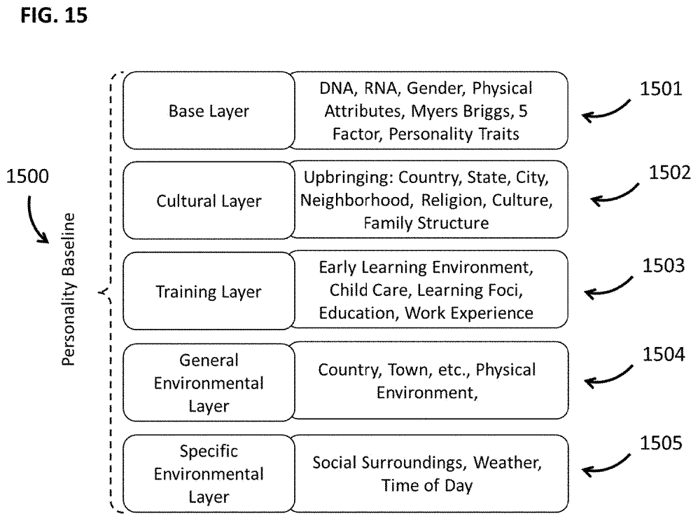

In order to calculate the impact on the Baseline Personality, there must first be a way of notating the state of the baseline personality. For that, a series of matrices with each matrix being a number of dimensions within a social or psychological domain and each layer being a mask or function acting on the layer below it are used. FIG. 15 depicts a block diagram of the components that make up the Personality Baseline 1500. There is the Base Layer 1501 made up of DNA, RNA, Gender, Physical Attributes, Myers Briggs, 5. Factor, Personality Traits; the Cultural Layer 1502 made up of Upbringing, Country, State, City, Neighborhood, Religion, Culture, Family Structure, etc., the Training Layer 1503 made up of Early Learning Environment, Child Care, Learning Foci, Education, Work Experience, etc., the General Environment Layer 1504 made up of Country, Town, Physical Environment, etc. and the Specific Environment Layer 1505 made up of Social Surroundings, Weather, Time of Day, and other relevant factors.

With regard to the robustness of the data within each matrix, it is not necessary that the descriptions be completely accurate. If someone is described as being a 13% on the scale of Narcissism, it does not matter if that is an accurate number because the number is not the point. The purpose is to get to a personality result and so the system will learn over time to quantify the personality factors based on the actual behavioral results and will over time adjust the weighting of the various parameters that make up our matrices, masks and functions. The training set is, initially, the behavior analysis as described by the Expert System. The Expert System is linear with each link in the forward chain being derived from its antecedents. However, in psychological systems, there are many factors and they are not necessarily deterministic. Instead, hundreds of other corollary factors may be associated with each projected behavior. For example and without limitation, the components of Narcissism may be; 1) have an exaggerated sense of self-importance; 2) have a sense of entitlement and require constant, excessive admiration; 3) expect to be recognized as superior even without achievements that warrant it; 4) exaggerate achievements and talents; 5) be preoccupied with fantasies about success, power, brilliance, beauty or the perfect mate; 6) believe they are superior and can only associate with equally special people: 7) monopolize conversations and belittle or look down on people they perceive as inferior, 8) expect special favors and unquestioning compliance with their expectations; 9) take advantage of others to get what they want; 10) have an inability or unwillingness to recognize the needs and feelings of others; 11) be envious of others and believe others envy them; 12) behave in an arrogant or haughty manner, coming across as conceited, boastful and pretentious; 13) insist on having the best of everything. If a person has a strong association with all these components they are certainly quite narcissistic. However, if they are moderate on half of the components, they are still probably narcissistic but to a lesser degree. Conversation analysis may be performed on people with known psychological profiles, in this case a 13% narcissistic person. Typical responses and cues will be determined from these conversations using a set of cues as defined, initially, by psychologists. A constructed set of principles that weigh on the decision about degree of narcissism are thus constructed. Similar lists for all of the other psychological components are constructed. All known personalities that are near 13% Narcissist may be observed and to determine what other factors make up their personality and when other personality traits are found, they are mapped back to the measure of Narcissism. Next groups of factors may be used as input vectors for a Neural Network. A Neural Network trained using a machine algorithm to predict a label for a set of behaviors where the label is based on a scale of personalities measure may be used to label the groups of factors based on the scale of personalities measure. Then the language that created these factors (e.g. the cat in our original training set) is used to determine what language creates which tendencies with regard to psychological definition. From that, language that corresponds to different psychological profiles can be generated.

### The Base Layer

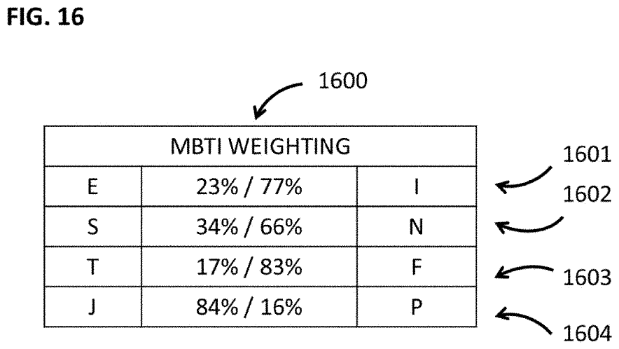

The first component of the Base Layer is the DNA. A comprehensive simulacrum of a human includes many if not all of the factors that influence the personality of a human this includes genetic make-up. According to aspects of the present disclosure, the DNA of the base layer may be represented as important known genetic sequences that influence personality or as genetically preordained conditions that influence personality. Information for the DNA in the base layer maybe for example and without limitation may be factors which impact personality like physical gender and gender identity, body type, coordination, visual and aural acuity, and other physical primitives like tendencies for heart disease or diabetes. There are also psychophysical primitives like dyslexia and left-handedness. The DNA factors may be the first dimension of the Base Layer Matrix. These genes may or may not express themselves based on their transcription and regulation by RNA and so RNA forms the next dimension of our Base Layer Matrix. RNA expresses itself differently over time and so has a dynamic effect—mostly in the early phases of life. In addition, during the early phases are sociological impacts, some very early in development like breast-feeding or sleep training. The dimensions of the matrix relating to DNA and RNA may be defined by geneticists and may change as information increases about what effect DNA has on personality. The dimensions of the matrix for very early development may be defined by early childhood psychologists. It should be noted that each entry in the matrix must be weighted. Again, we can start with basic weightings based on the opinions of experts in the field but the ultimate weightings and their impact on personality will be updated over time based on observation and experience. The next dimension of the Base Layer Matrix is the personality continua as shown in FIG. 16. As discussed above, in some implementations according to aspects of the present disclosure Meyers Briggs Type Indicator (MBTI) percentages in matrixes of weightings 1600 along the axes of Extraversion->Introversion 1601, Sensing->iNtuition 1602, Thinking->Feeling 1603, Judging->Perceiving 1604 provide one set of numbers for a dimension of our Base Layer Matrix. Another dimension may be by the Big Five personality traits: Openness to experience, Conscientiousness, Extraversion, Agreeableness and Neuroticism. There is one more dimension represented by the other personality continua such as Machiavellianism, Need for Achievement, Need for Cognition, Authoritarianism, Narcissism, Self-esteem, Optimism and Alexithymia. All of these factors, taken together may be used to create a Base Layer Matrix. This is a representation of personality at its most basic level. The next layer is the Cultural Layer.

### Culture Layer

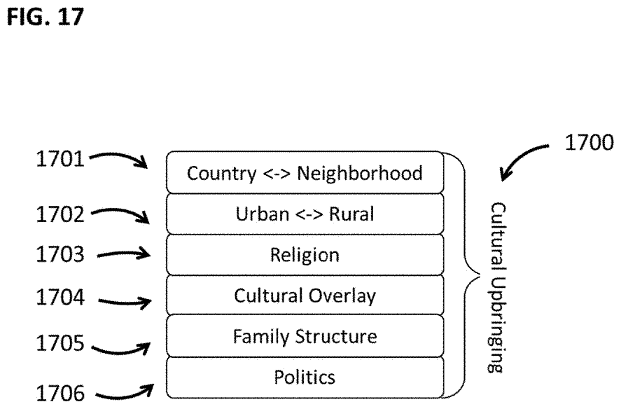

The cultural layer captures how the IS is conceived to have been raised. This layer contains background information about the IS as shown in FIG. 17 such as and without limitation; what country, state, city and neighborhood 1701 did the IS grow up in? Did the IS grow up in an urban or rural area 1702? What Religion is the IS affiliated with 1703? What Political climate was the IS raise 1706? What Cultural was the IS raised in 1704 and what Family Structure 1705 was part of its upbringing.

There is much variety across cultures. “Asian cultures are more collectivist, and people in these cultures tend to be less extroverted. People in Central and South American cultures tend to score higher on openness to experience, whereas Europeans score higher on neuroticism.” These differences are all captured by the culture layer and contribute to different personalities in the IS.

As another example of the effect of culture on personality, people who live in collectivist cultures (typically Asia, Africa and South America) value social harmony, respectfulness, and group needs over individual needs whereas people in individualist cultures (typically North America, Australia, Europe) display more individualistic personality traits.

There also seem to be regional personality differences within the United States. Researchers analyzed responses from over 1.5 million individuals in the United States and found three distinct regional personality clusters: “friendly and conventional . . . ; more relaxed, emotionally stable, calm, and creative . . . and stressed, irritable, and depressed.”

These cultural data are fit into the layer cake of matrices. According to some embodiments of the present disclosure, all cities and villages and all families need not be represented. Only sufficient number of examples are needed to create our personalities. For example and without limitation, creating a customer care IS Instance only a few representative backgrounds are sufficient, e.g. 100 US cities with populations between 200,000 and 1,000,000—a representative sample from all US cities of that size are not necessary. Looking at the Cultural Upbringing Layer Cake, description may begin for example and without limitation, with locale going from less granular to more granular: Continent→Country→County→Town→Neighborhood. Students of Psychology and Sociology can map behavioral tendencies onto each of these layers. So, for example, based on collected MBTI data, Nicaraguans are 15% more extraverted than average and Chileans are 11% more introverted than the global average. The next layer is Urban<->Rural. There are known different attitude differences between urban—suburban—rural and spaces in between. These are coded—again as an expert system to begin with combined with analysis of real conversations (text, phone, movies, etc.—see below) and over time, they are fine-tuned based on feedback from users and based on rapport with others of like minds.

Using a similar approach, other various cultural dimensions may be added: Religion, Cultural Upbringing, Family Structure and Political Environment. These, again, are seeded by sociologists and psychologists but will be informed by analysis of movies and TV shows, chat sessions, text messages, voice messages and email.

### Training Layer

In this context training is referred to as the IS's education or learning beginning at a very early age. This layer will answer questions about the IS such as and without limitation: What is the impact of the early learning environments, from breast feeding and eye contact and being read to, to Child Care. As they get older, what is the learning environment? For example, is it co-ed? Are there large classes or small? Is it disruptive or focused? What about higher education and work experience? How was our IS Instance trained? Did s/he go to University? What was their major? Did they join a Fraternity/Sorority? What were their grades? What about graduate degrees or certifications? What about previous work history? All of these factors play into the personality of our IS Instance. Essentially, a virtual Curriculum Vitae is created for our IS Instance. The training layer does not have to create actual events (e.g. “Remember that great AEPi Halloween Beer Bash in 1995. Jeffery got so drunk”) for the IS to remember. It is sufficient for the training layer to create a rich bible for the IS ensures a unique human-like personality. In some implementations, the character bible may be created by users or software programmer with a tool that allows the creators to write unique histories for the IS. In other embodiments, the ISs create their own instances with their own bibles based on the situation. In yet other embodiments, hybrid models may be built where salient characteristics may be outlined and the IS will provide choices to choose from—for example and without limitation branches in an IS Instance's bible may be chosen while the underlying architype for the IS immutable.

### General Environment Layer

The General Environmental layer describes the context of the IS's current state. In other words, it describes the events that have led to the IS's contact with the user. This layer may answer questions such and without limitation: where does this IS work? Some of the same factors that affected the early learning phases of life impact the work or play environment. Is the IS Instance in a call center, in a bar, in a cube, making sales calls, or in a law office working as a litigator? In some embodiments the General Environment layer may start with a basic career taxonomy of: Agriculture, Food and Natural Resources; Architecture and Construction, Arts, AudioNideo Technology and Communications; Business Management and Administration; Education and Training; Finance; Government and Public Administration; Health Science; Hospitality and Tourism; Human Services; Information Technology; Law, Public Safety, Corrections and Security; Manufacturing; Marketing, Sales and Service; Science, Technology, Engineering and Mathematics and Transportation, Distribution and Logistics. Then overlay on that the same cultural and contextual variables that were used in the context of upbringing: Continent→Country→County→Town→Neighborhood; Urban→Suburban→Rural. Then additional branches may be added such as Large Company↔Small Company, Large Building↔Small Building; How diverse is the work force (on multiple axes); what are the politics/religion of the company/executives; etc. The domains and sub-domains of the taxonomy may be defined by social scientists but the categories, their weighting and importance are all dependent on the outcomes of contact with users and how relevant those inputs are to the value of those outputs.

### Specific Environment Layer

The next layer is the Specific Environment Layer. Here the most recent element for creation of IS Instance behavior is captured. This layer may answer questions such as and without limitation: What is the weather like? How was the traffic? How was my morning? For example, based on the constructed family of our ISI, they could be in a generally happy marriage with two kids who have to be gotten off to school and at a normal distribution of surprise events (kid got sick, homework was lost, etc.), the mood of our ISI and hence its behavior is impacted by these preparatory factors.

### Behavioral Analysis

The next task of training is for the IS to learn human behavior. There are many Interactive Voice Response (IVR) systems that use Automatic Speech Recognition (ASR) techniques and Natural Language Processing (NLP) for analyzing human behavior in the marketplace today. The approach here is to use that as a conversational baseline. According to aspects of the present disclosure the IS is configured to bring is not just immediate context (this person is shopping or at the beach, etc.) but personal and social context—knowing about human social behavior.

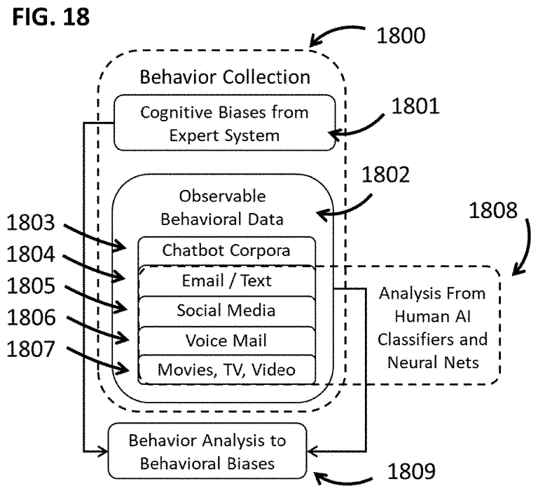

FIG. 18 depicts an overview of behavior collection 1800 and weighting according to aspects of the present disclosure. Initially the expert system may be primed with Cognitive Biases Collected from our Expert System 1801 and the corpus of Observable Behavior Data 1802 may be added. Embodiments of the present disclosure may use the corpora of chat bot data 1803 and analyze more normal/social conversational environments. These may include without limitation email and text 1804, social media 1805, voice mail 1806, movies, TV shows and streaming video sources 1807. Video media is very rich socially and there is a huge wealth of data that may be accessed. There is a risk that many movies and TV shows are not typical or “normal” and so we will employ Human AI Classifiers 1808 (For example and without limitation a Mechanical Turk or various other networks of Human AI Classifiers) to grade conversations on a normalcy scale. Later when the IS is chatting with humans, it may learn from the human responses. Additionally, it may chat with other IS Instances (using a GAN) and we can employ the same humans to analyze the conversations. Depending on the particular corpus of communication data, we will need a number of different approaches to do the analyses. We will then map our Behavior Analysis to Behavioral Biases 1809.

According to aspects of the present disclosure, Movies and TV may be one source of information used to train the IS. These are not necessarily representative of typical long-term arcs. Many genres always end happily others are snarky, situation comedies often rely on people telling a lie and then comedy ensues from that. However, in many of these same titles the minute-by-minute behavior is very human. The punch line or shocking event is often surprising and not typical but all the in between actions are normal. In some embodiments, a Mechanical Turk/Classifiers is fed with tens of thousands of video assets to scale for normalcy. This approach works for movies and TV but there are other video assets—most notably streaming social media video (e.g. YouTube, Facebook video, etc.). In some embodiments, a Neural Network 1808 is used to perform social analysis and filter the “non-normal” behavior. The value of this corpus will, almost by definition, be different from the value of the other social analyses and so they (and in fact each group of analyses) must be kept separate (labeled as its own corpus).

The next corpus of data is chat-bot data. This will be particularly relevant when people are asking questions, asking for specific answers. The responses from the various chat bot corpora will be focused on accuracy. According to aspects of the present disclosure, the IS may be trained to not necessarily provide the right answer but rather the most human answer. One valuable result, which comes out of chat bot data, is when the bot gets it wrong. Because it is real humans who are asking the bots, they will not always be satisfied with the “correct” answer (ignoring for the moment the times the bot misunderstands or misinterprets the question). Thus, in some embodiments if, a customer is having difficulty because the software is not designed to solve the problem they are trying to solve, the responses will often be unsatisfactory to the humans rather than saying, “I am sorry, but our software does not do that.” A more sensitive bot might say, “Let me see if I am properly understanding the problem you are trying to solve.” Then after properly confirming that the bot “understands” the question, they might direct them to the proper software to solve their problem (a bit like the Macy's Santa Clause in Miracle on 34^{th} street who sends the families to the competition greatly increasing the value of the Macy's brand). Perhaps the bot is even “their bot,” that is they stay with the customer to help them properly install their other software (in reality, the same bot persona would then be working for the competition and the relevant portion of the customer's data would be shared with permission).

Next on the list of corpora for behavioral analysis may be social media analysis. There are acres of communication data within this grouping and it is typically curated. People often try to show their best side to their acquaintances and their more genuine side to their close friends. Anonymous or pseudo anonymous posts may be particularly atypical and should probably not be included at all. Private posts will be of particular value because of the natural candor typically associated with them (gratuitous posts like “another perfect day” or “life sucks as usual” are filtered out). Again, this is bucketed into a number of separate corpora and the weighting of the humanity is defined by the analysis of the actual responses to the behaviors.

The last buckets of corpora are text, voicemail and email. Text is the most natural in terms of tone. In some embodiments, emoji's and acronyms are expanded to real language descriptions of the emotion or context expressed by the emoji or acronym. Knowing the relationship between and among the members of the various chats will provide context or metadata for each group. A person will speak differently to their mother than to their friend and differently to their friend that to a group of 4 friends. The application of this context will be very valuable for our AI training. Voice mail is, in some ways, a subset of text data. It is generally targeted at a single person or household. Users or voicemail are typically a different demographic than those of text messages and may represent a different or older set personalities. Young people today rarely use voice mail. Email may require metadata to describe the situation and break into multiple corpora. In some embodiments, a thread may be parsed into different corpora (for example and without limitation, personal communications inside business emails).

The next task is to correlate the behavioral observations above to the list of Behavioral Tendencies (Behavioral Biases) 1809. This parsing answers the question what behaviors are associated with which Tendencies. Here experts are used in two phases. First experts class behaviors into groups. For example, and without limitation are people short-tempered, empathetic, anxious, or relaxed. The experts create a taxonomy of emotional groupings and then our Human Classifiers to label all of the behaviors. These behaviors and their labels are then used to train machine-learning systems (i.e. the Neural Networks).

### Imputing Behavior Biases to Individuals

Now every human has different degrees of each Behavioral Bias. One may be very “analytic” and “realistic” while another might be more emotional and prone to hyperbole. Even when prone to hyperbole, that is usually limited to some domains. The same person who exaggerates their role in their high school basketball team might be very accurate when remembering the details of their trip to Greece. Remember that the Situational Baseline is essentially the IS's personality as developed up the stack (DNA⇒Early Development+Gene Regulation⇒Basic Personality Elements⇒Development Filter⇒Relationship Filter).

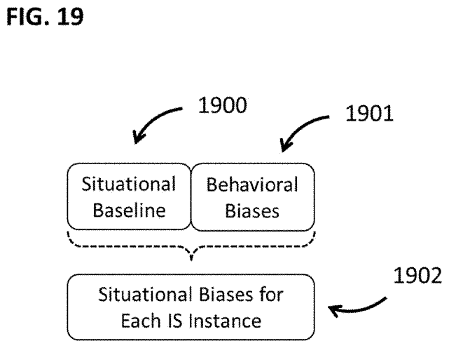

As shown in FIG. 19 the Situational Baseline 1900 is mapped that against each of Behavioral Bias 1901 to create a set of Situational Biases for each IS Instance 1902. By way of example and not by way of limitation, start with one IS Instance and then extrapolate to instances that are more general. For example, an IS Instance may be generated with parameters to be a heterosexual woman, 35 years old, raised in a small Midwestern town.

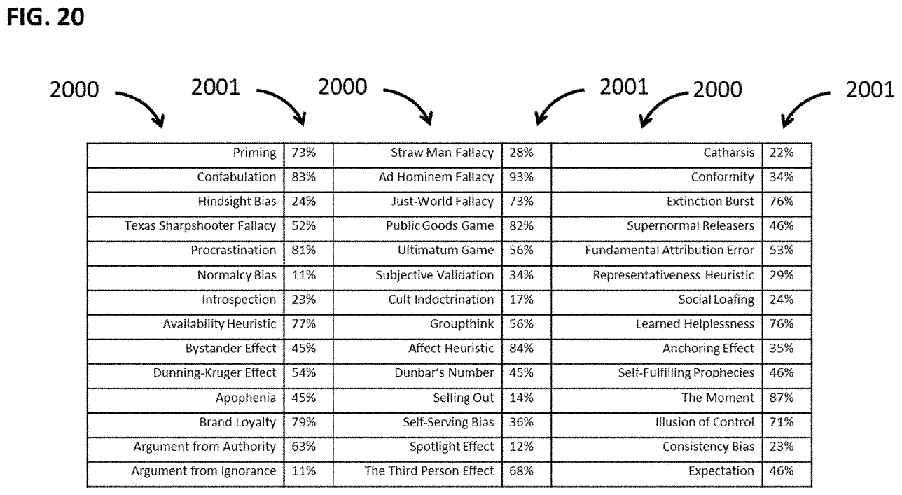

She was raised as a Protestant but did not go to church regularly—however, she has strong fairness values. She has two siblings, both living, an older brother and a younger sister. Her brother is gay and that informs her openness to relationship (not very judgmental). She is however very judgmental with regard to abortion and right to life issues and believes that there are enough people who want children and so no life should be wasted. She is an EFTJ (64, 81, 59, 50, Myers Briggs) and her 5 factors are Openness (66%), Conscientiousness (34%), Extraversion (72%), Agreeableness (48%) and Neuroticism (32%) and her other personality traits are Neuroticism (53%), Machiavellianism (14%), Need for Achievement (21%), Need for Cognition (73%), Authoritarianism (26%), Narcissism (14%), Self-esteem (58%), Optimism (87%) and Alexithymia (13%). She enjoys crossword puzzles and medical dramas. There are potentially many more components to her character bible, but this gives some idea of who the IS is as a virtual person. Now as shown in FIG. 20, we can map all of the psychological parameters to a multitude of Behavioral Biases 2000 and provide a weighting to each 2001. These are baseline biases and are not yet mapped to any specific situation. However, they do each have a baseline value, that is, “how pronounced is your Behavioral Bias?” Using a number of Psychologists, we will map the Myers Briggs and Five Factor tendencies to our Behavioral Biases as discussed above. This can be done on any scale but by way of example and not by way of limitation, a percentage with higher numbers being more prone to the Bias and low numbers being less may be used.

As the IS, interacts with other users and ISIs it gets more mature, the number, names and weighting of biases will change. Even beginning with an initial set of biases, the ISI has a set of basic personality factors for how it will be coming into a new situation. Now we can begin to apply the IS with biases to specific situations. Remember that the Behavioral Bias is only one component of the personality and so as we prepare to address specific situations, the complete personality bible is needed. For example, the sensitivity that our heterosexual woman above has to abortion and adoption would strongly influence how she behaves in certain situations and she might not be the correct personality for a Planned Parenthood early pregnancy support group but she might be the right profile for a church based early pregnancy support group.

### Imputing Behavior Biases to Situational Environments

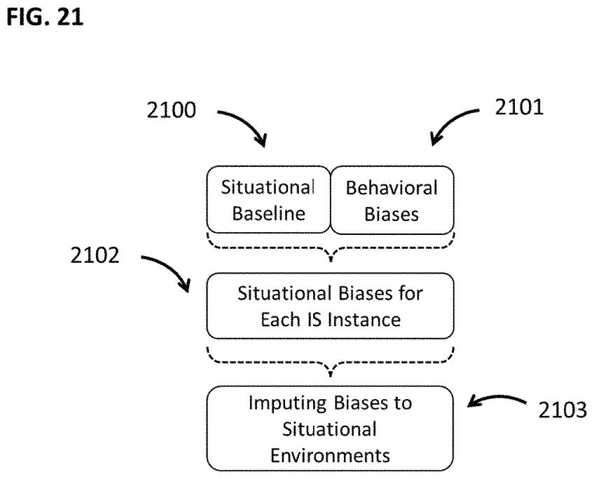

FIG. 21 shows the next layer in the stack, mapping the IS Instance to the situation it is in. The Situational Baseline 2100 and the Behavioral Biases 2101 are mapped to create a Situational Biases for Each IS Instance 2102 and next we will Impute Biases to Situational Environments 2103.

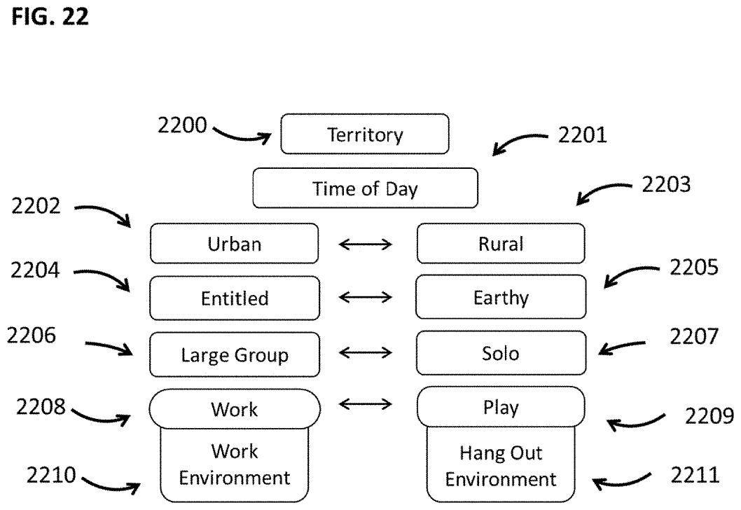

This layer answers the questions such as, without limitation, is the IS selling makeup at a makeup counter, providing customer support, acting as a health worker, or a counsellor at a resort? Here some situational behavioral data is useful. This may begin with an Expert System having axes based on psychological data. As can be seen from FIG. 22 there are behavioral parameters based, at the highest level on the territory 2200 (Siberia is very different from Cannes). Everyone is also affected, to some degree, by the time of day 2201 where they are. Many of the other parameters are continua between two different aspects. For example, and without limitation, there are deep social differences between urban 2202 and rural societies 2203. For this, we can use population density. There is also a continuum between Entitled 2204 and Earthy 2205. People act one way in Beverly Hills and another way in Compton. How crowded is the environment? Is the IS working in a busy mall or in their home alone (this is by way of establishing personality behaviors—it doesn't actually have to have any physical instantiation, in some embodiments the IS will ‘live’ in the cloud)? Other factors would include but not be limited to working or playing in a Large Group 2206 or Solo 2207, what kind of Work 2208 do they do and what kind of Play 2209 What is their environment like at work 2210 and where they Hang Out 2211 in their free time. Now as we look at various environments, we can dig down a bit based on type. Is it an insurance office?Graphics design house? Software Programmer cubes? Is it a Library or at the beach or on a cruise ship? We will create a complete taxonomy using an expert system created by humans. It does not matter if the system is completely accurate because the AI will iterate over time and develop its own taxonomy based on experience.

Once the basic parameters of our expert system are set from Psychology and Sociology data the Classifiers may map expected behaviors to social environments. In this case, gathering a large amount of perceived social mores are gathered is more important than determining an accurate representation of societal norms. This may be done through surveying or otherwise polling a large population. After a sufficient number of people (e.g., about a thousand) have taken surveys on a specific behavior and environment the system will have a reasonably accurate social perspective.

By way of example and not by way of limitation, suppose the IS is a bank teller. Now, we are not yet in a specific interaction with an individual, but we do know a number of things about the environment. Say our teller is in a rural bank where people tend to be friendly and social. The bank is not typically crowded and so people usually do not have to wait and the transactions usually start with a conversation about the weather or about some recent event or fair. Let us assume that our teller has a reasonably long (virtual) commute and would know about the traffic that day. All of these things play into the baseline behavior of the IS Instance in this environment.

### Ordering the Data

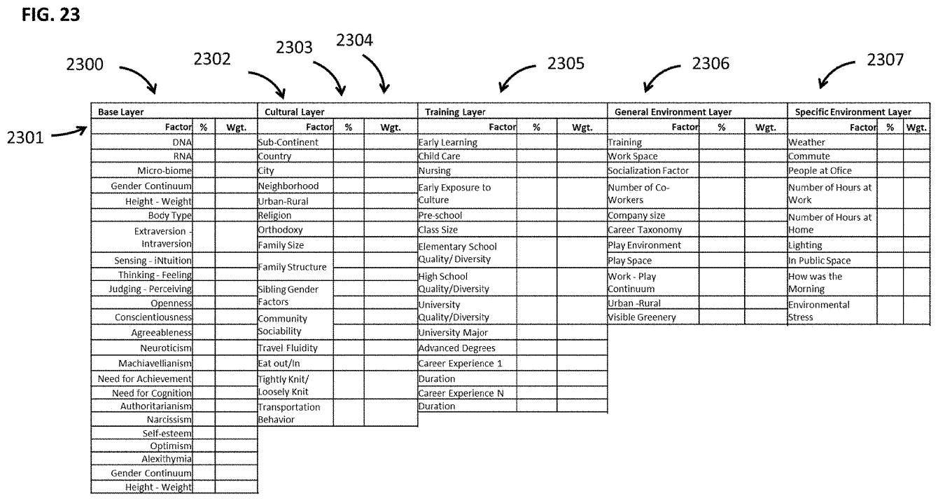

The next stage in this stack is to create the full psychological profile that the IS will bring to its human interaction. In order to do this a matrix of arrays to hold and operate on data as shown in FIG. 23 may created. Various data sets are assigned to columns and rows within our arrays. Though this can be done in many ways, let's choose some arrangements by way of example and not by way of limitation. Array 1 is the Base Layer 2300 of our Situational Baseline. Within that Array the factors 2301 are laid out, Row 1 is DNA, Row 2 is RNA, Row 3 is the Microbiome, Row 4 is the Gender Continuum and so on through the rows to include Physical Attributes followed by rows for Myers Briggs axes, the 5. Factor Personality Traits axes and the other personality traits.

Now, continuing up the stack to add the next array. This array is the Cultural Layer 2302. Starting with the physical location, the rows become: Sub-Continent, Country, State, City and Neighborhood. Each Factor has a Percentage 2303 and a Weighting 2304. So in the religion example, an ISI might be fairly religious—say 73% but it might have very little impact on its life and so the Weighting might be just at 15%. Next would be the Family components of the Cultural Layer with continua like closeness, size, gender makeup, parental structure, etc. Now Row 4 is the Cultural Layer with rows like where do you fit in the community? How social are people in your community? Do you travel to other communities? Do you eat out often? Is the community tightly or loosely knit? Other cultural factors might be the Religion with columns representing axis of religious impact like orthodoxy, cultural association.

Included in the Cultural Layer are the earliest development factors like family size, number of siblings and basic cultural backdrop (religion, cultural grouping, etc.). This is, of course extensible and the rows and columns within this array can vary, expand, contract, etc.

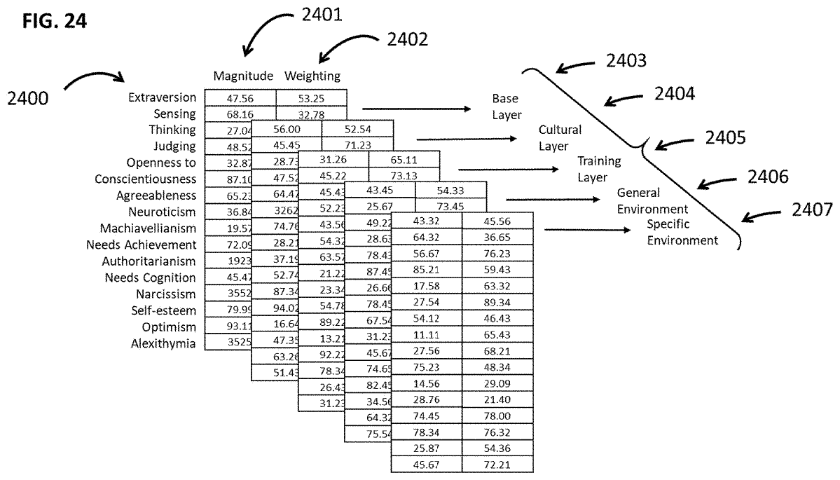

In FIG. 23, there is a rough approximation of some of the fields in the various arrays understanding that an excel snapshot does not convey the multidimentionality of the arrays but still gives some sense of the breadth. FIG. 24 illustrates another approach to visualizing the data and may help clarify the fact that it is made of multiple arrays.

Using the same line of thinking for the Training Layer 2305, the General Environmental Layer 2306, and the Specific Environmental Layer 2307 are created. All of these layers will combine to create IS Instances up to the point of interacting with humans.

While an excel snapshot gives some sense of the breadth, it does not convey the multidimentionality of the arrays. FIG. 24 shows a different approach to looking at the data in is a more examplar way to visualize this and may help clarify the multidimensionality of the arrays. 2400 shows the column which represents each of the elements that make up the Base Layer showing both the Magnitued 2401 which represents how strongly this personality trait is within the continuum of the personality binaries (like Introversion vs Extraversion) of this particular IS and the Weighting 2402 indicates how much this trait should be weighted when making decisions in social situations or how much that aspect of personality should be considered when weighing the relevance to a particular situation. Each dimension of the array is associated with a different layer including the Base Layer 2403, the Cultural Layer 2404, the Training Layer 2405, the General Environment Layer 2406 and the Specific Enfironment Layer 2407

### Mapping Data to Behaviors

As discussed above, data is captured from chat sessions, text messages, videos, etc. but still needs to be mapped to personality traits that will be represented.

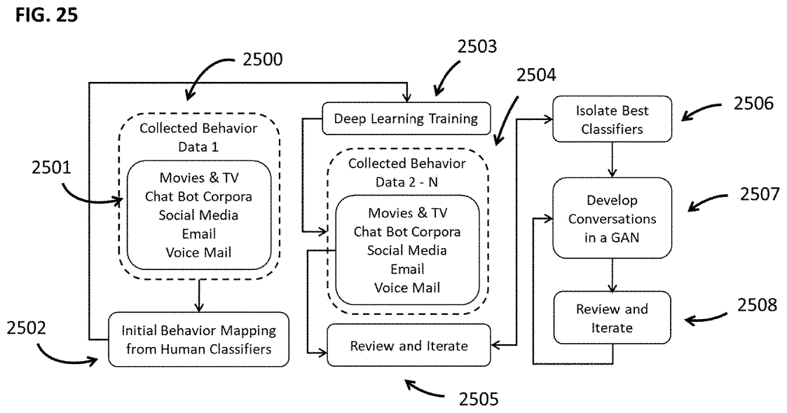

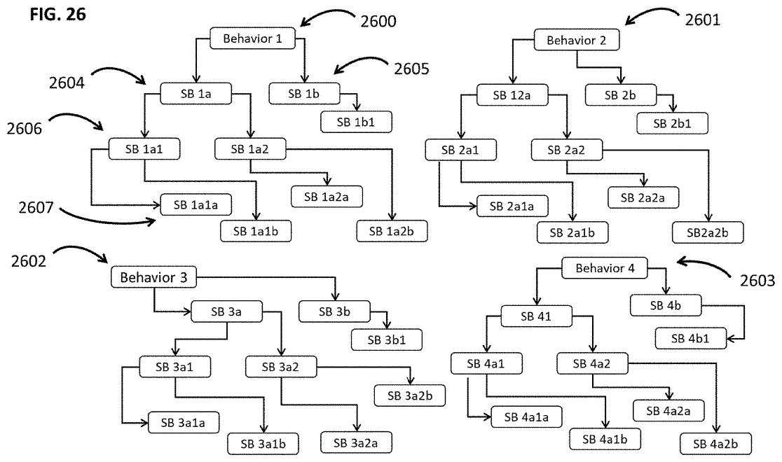

FIG. 25 depicts the refinement of datasets according to aspects of the present disclosure. Collected Behavioral data 2500 is generated, initially, by Human AI Classifiers as they monitor behavior and commentaries associated with Movies & TV, Chat Bot Corpora, Social Media, Email and Voice Mail 2501 and categorize that behavior. From this corpus, we will create an Initial Behavior Mapping from Human Classifiers 2502.

After the initial set of Collected Behaviors are analyzed by our Classifiers, these tagged bits of behavior (conversation, physical behavior, etc.) are labeled according to the taxonomy described above. All the different elements of the Base Layer, Cultural Layer, Training Layer, General Environment Layer and Specific Environment Layer are labeled. Once we have an analysis of various elements, one or more Deep Neural Networks (DNN) 2503 may be used to learn these classifications.

Then the DNN may analyze a second set of data 2504. The accuracy of these mappings may be reviewed by Human AI Classifiers (perhaps a sub-set of those above who have shown to be more skilled). We will keep doing this, Reviewing and Iterating 2505 until the DNN does as well as the best classifiers 2506. In parallel, scores may be generated on our classifiers ability to classify. This is not necessarily psychological accuracy but rather popular behavioral accuracy. That is, if a Human Classifier most often agrees with the most popular opinion, they get a higher score as a classifier. Once a few rounds of this are finished and there a good idea of how humans classify behavior, the accuracy of the prediction may be checked against informed psychological beliefs held by social science and psychology experts.

### Creating the Social Taxonomy

From the analysis of conversations as labeled by Human Classifiers a taxonomy of social situations may be created. Again, Psychologists and Sociologists can create the baseline set of expectations and groupings structuring them into Behaviors 2600, 2601, 2602, 2603 and Sub-behaviors 2604, 2605 and so on further down the taxonomy 2606, 2607. And again, these groupings are not totally dispositive, they are merely a starting point. The success of any choice is measured by how closely the taxonomy of social situations achieves a set goal. This begins to get to the biggest question of all which is how do are goals set, managed, updated and governed. This Conversational Taxonomy will be augmented and continuously adapted based on developments in Natural Language Processing (NLP), Sentiment Analysis and Emotion Detection. Note that Emotion detection is not limited to text and voice but is also making great strides using visual cues.

### Creating a Full Baseline Personality

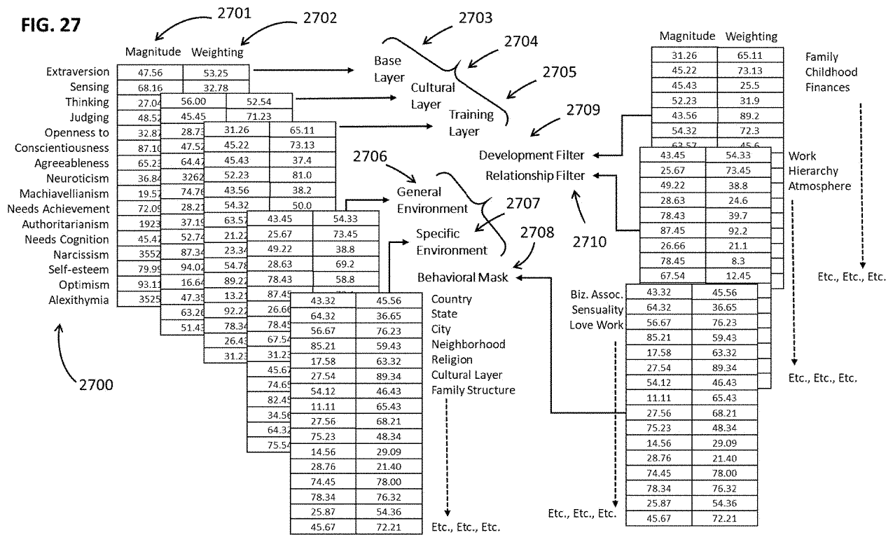

The next step is to take all of this data and use it to define a full Baseline Personality. FIG. 27 builds on top of FIG. 24. This is the personality of the ISI at the point when a human first interacts with it. Up to this point, we have created a very wide and deep matrix of Factors 2700. Initially, we will create a dashboard that humans can use to put together a personality. All of the data about the three initial layers (Base, 2703, Cultural, 2704 and Training, 2705) and the two environments (General, 2706 and Specific, 2707) can be arranged as a series of columns and rows with faders or other input types to change values and they can be tested by humans for basic functionality. At this point, our IS Instances will be quite logical. They will still respond with warmth and humor and all sorts of other human emotions, but they will be quite (probably too) logical. After we have created our Full Baseline Personalities, we will add in the Cognitive Biases or Behavioral Masks 2708 and the Development Filters 2709 and the Relationship Filters 2710.

How will develop a corpus of situations upon which to operate our functions (Biases) be developed? A very limited subset of situations for imputing biases may be used initially and over time, the system may train to impute biases (just as humans do) to more and more situations.

Limiting the scope of the initial interactions will create a base on which to develop. Customer support on the phone may be one of the first areas for development. This is for a number of reasons including the large corpus of historic data including experience at communication with customers. A first goal may be for one ISI that solves problems for one customer. The ISI may be primed with a corpus of support conversation data so that it can already be at the current level of chat bots. On top of this, our first set of our psychological primitives may be overlaid so that we can add humanity to the interaction. Basic human interactions (hello, how are you, how can I help, etc.) may be the initial psychological primitives used. In parallel psychological meaning associated with the questions and conversation may be gauged. In the first phase (Customer Support with voice only), communication id only through sound and with visual or other perception other the ability to discern emotion/intention is limited but just adding voice analysis will add greatly to the ability of the IS to understand and respond. The next step would be video chat. Eventually, other senses may be added so that there is functionality similar to physical beings (pets, robots, etc.).

Returning to the Full Situationally Aware Profile, there is a large set of elements based on the five layers (Base—2703, Cultural—2704 and Training—2705), the two filters (Development—2709 and Relationship—2710), the two environments (General—2706 and Specific—2707) and the mask (Behavioral—2708).

As can be seen from the above, there are many variables. However, groupings and sub-grouping algorithms may be used to control a dashboard to set the variables for the different parameters of the personality (ISI) over these layers, filters and masks and, as shown below, use those parameters to construct appropriate responses in real time.

Once an ISI is created, it may be tested drive by our Human Classifiers who may judge the ISS and that judgement may be used to refine the ISI. Once a reasonably good set of ISIs has been established, they may be trained with each other. Then Human Classifiers may be used again to judge the results from the unsupervised training and more insight may be gained from observation of the unsupervised training process.

Generating Behavior Functions

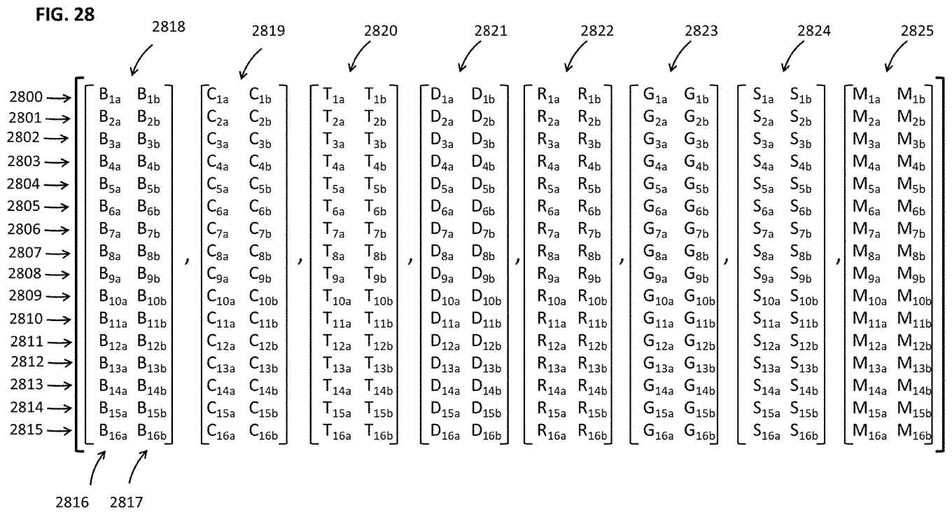

ISI personalities may be described using a multi-dimensional matrix. For convenience, the matrix described herein is limited 16×2×8 (E.g. Extraversion 2800, Sensing 2801, Thinking 2802, Judging 2803, Openness 2804, Conscientiousness 2805, Agreeableness 2806, Neuroticism 2807, Machiavellianism 2808, Achievement 2809, Cognition 2810, Authoritarianism 2811, Narcissism 2812, Self-esteem 2813, Optimism 2814 and Alexithymia 2815)×(Magnitude 2816 and Weighting 2817) with 8 dimensions (our layers, filters and masks). Psychologists and Sociologists will choose the 16 most significant factors (to keep our matrix dimensionality simple for matrix math). Lettering may be used to represent each of the Dimensions or Layers, Filters and Masks: B (Base Layer—2818), C (Cultural Layer—2819), T (Training Layer—2820), D (Development Filter—2821), R (Relationship Filter—2822), G (General Environment Layer—2823), S (Specific Environment Layer—2824) and B (Behavioral Mask—2825). It should be understood that the ISI personality matrix may be any size configured to describe the personality traits of the ISI. Now representation of the personality upon which an IS can act is created. In a way not dissimilar to the way a Convolutional Neural Network (CNN) works, we can convolve our layers to create an aggregate layer. Looking at the matrix in FIG. 28, we use Ashu M. G. Solo et al. “Multidimensional Matrix Mathematics: Notation, Representation and Simplification, Part 1 of 6” Available at http://www.iaeng.org/publication/WCE2010/WCE2010_ppl824-1828.pdf the contents of which are incorporated herein by reference, approach to representation of multi-dimensional matrices.

Now, a representation of our Baseline Personality has been created. As mentioned above, this is the personality of the IS Instance before it has interacted with any humans. Some human interactions will create changes in the IS Instance and those should be stored as either a new Instance or as a described modification to an existing Instance. Shown above there is a set of Behavioral Biases and a set of circumstances in which these behaviors occur. Now that a Psychological description of the IS Instance is established, the Behavioral Biases may be applied to each interaction. The situations that have been defined may be mapped to the associated biases through the lens of any IS Instance. The 3-dimensional personality matrix may be represented as Φ(Phi). Each of the 48 Behavioral (Cognitive) biases has two factors: Magnitude and Weighting (a 48×2 matrix). The behavioral bias matrix may be represented as A(Lambda) and an additive matrix calculation may be performed in in each situation as: f(Behavior)={Φ}·{Λ}.

### Feedback Loon

The feedback loop is very important. The ISI may be making billions of small decisions and it is critical that it learns how well each of those decisions did. To that end, the system may monitor behavioral cues and use them as a measure of the ISI's performance. Some examples of the obvious indicators of non-success are, without limitation: Delay in response (not counting overly long delays, which indicate absence), call back on the same topic (using textual analysis to determine if something was not understood), anger, dismissiveness, etc.

On a deeper level the system according to some aspects of the present disclosure may (with visual and voice analysis) be able to monitor emotional sentiment. Particularly the system may be looking for empathy, calmness and engagement. It will use these metrics to determine how successful the ISI is at its task with the goals being set in advance. Perhaps the best goals are empathy, lack of tension, engagement, words (genuine) of appreciation but depending on the desired outcome, any set of goals could be chosen (e.g. perhaps the ISI creators want someone to be angry about hurricane victims that the government is not helping, etc. When a particular response or approach is found that leads to undesired results, less of that approach or response will be used or it may even be deprecated it and when certain approaches lead to successfully approaching our goals, the ISI may be changed to behave that way even more. Additionally, in some embodiments it may be found that certain personalities do not work well with certain human personalities and so tweaks can be done to the IS Instance's personality or completely new personalities can be tried—particularly if the personality of the human is known or has been imputed based on behavior.

### Bible Software and Dashboard

In some embodiments of the present disclosure, a dashboard may be created from the different personality parameters that allow humans to try different variables of the ISI personalities. In other embodiments the IS may choose its own personality parameters based on the situation and the entities involved. Of course, a Personality Designer may manually set any of the 256 or more variables and then take the IS Instance for a test conversation or interaction. In some embodiments IS Instance may be modeled after a known entity, for example and without limitation, Abraham Lincoln or Katherine Hepburn or Meredith Grey from Greys Anatomy. In yet other embodiments, users could request a specific personality for the ISI or in yet other embodiments known personalities may be mixed, for example and without limitation; Winston Churchill mixed with Diane Sawyer with a voice like James Earl Jones and mannerisms like Harry Potter. In this way unique, fun and exciting virtual personalities with real human like interactions may be created.

### Response

Now that the various filters, masks and functions have prepared the appropriate response, our IS has to respond in a believable fashion in real time. In some embodiments to mask the computation times for responses, programmed delays may be added. For example after being asked a question the ISI may respond with an immediate “umm” or “huh” while it computes a longer better response. Additionally, according to some aspects of the present disclosure, physical responses: micro facial expressions and other body movements, voice timbre, breathing, sweat, skin coloration (blood flow), etc. are mapped to the appropriate response allowing the IS to understand human emotions.

### Applications

According to aspects of the present disclosure, the ISIs may be implemented in virtual environments such as video games, and text help lines. Additionally, other new virtual environments that allow more ‘real world’ interactions with the ISIs may be created where the ISIs may function in more traditionally human roles for example and without limitation the ISI may be a stock trader, a janitor, a doctor. The ISI may interact with the wider world through the virtual environment. Additionally, in some embodiments, this technology can be used with or without VR glasses or rooms for training.

According to some aspects of the present disclosure as more and more virtual characters in our online and in-game universes are created, they will interact and be part of a Virtual Social Network. Real users can, participate in our social network—sharing stories, photos, videos, etc. However, the virtual characters (ISI) can also join their own social network but they may also be part of a social network populated by any combination of real or virtual characters.

### Internationalization

The systems described above and below will function in any cultural environment. However, results will be different in different cultural environments. While some cultures (like the Dutch) may be very candid and blunt, other cultures (like the Japanese) are very subtle and contextually based. Psychologists, sociologists and others practiced in the arts will need to separate out the results for each cultural sub-grouping and an IS will need to function within that cultural environment.

### System

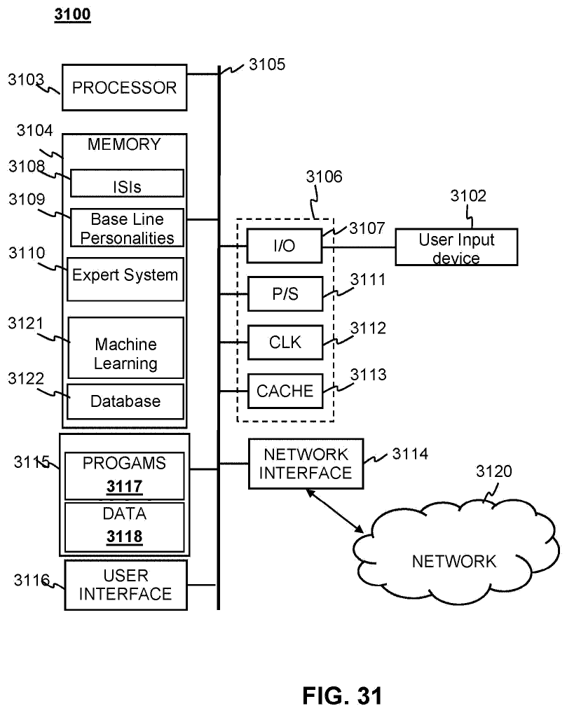

FIG. 31 depicts an intelligent agent system for implementing methods like that shown in Figures throughout the specification for example FIG. 5, FIG. 10, or FIG. 13. The system may include a computing device 3100 coupled to a user input device 3102. The user input device 3102 may be a controller, touch screen, microphone, keyboard, mouse, joystick or other device that allows the user to input information including sound data in to the system. The user input device may be coupled to a haptic feedback device 3121. The haptic feedback device 3121 may be for example a vibration motor, force feedback system, ultrasonic feedback system, or air pressure feedback system.

The computing device 3100 may include one or more processor units 3103, which may be configured according to well-known architectures, such as, e.g., single-core, dual-core, quad-core, multi-core, processor-coprocessor, cell processor, and the like. The computing device may also include one or more memory units 3104 (e.g., random access memory (RAM), dynamic random access memory (DRAM), read-only memory (ROM), and the like).

The processor unit 3103 may execute one or more programs, portions of which may be stored in the memory 3104 and the processor 3103 may be operatively coupled to the memory, e.g., by accessing the memory via a data bus 3105. The programs may include machine learning algorithms 3121 configured to label and weight collected behavior data and behavior biases in the database 3122 and to refine baseline personalities 3109 and IS instances 3108, as discussed above. Additionally, the Memory 3104 may have one or more expert systems 3110 that may be configured to generate a response from personality biases and behavioral biases stored in the database 3122 or as part of the baseline personalities 3109. These responses may also be part of an IS instance 3108. The database 3122 base line personalities 3109 IS instances 3108 and machine learning algorithms 3121 may be stored as data 3118 or programs 3117 in the Mass Store 3118 or at a server coupled to the Network 3120 accessed through the network interface 3114.

Input video, audio, tactile feedback, smell, taste, and/or text, may be stored as data 3118 in the Mass Store 3115. The processor unit 3103 is further configured to execute one or more programs 3117 stored in the mass store 3115 or in memory 3104 which cause processor to carry out the one or more of the methods described above.

The computing device 3100 may also include well-known support circuits, such as input/output (I/O) 3107, circuits, power supplies (P/S) 3111, a clock (CLK) 3112, and cache 3113, which may communicate with other components of the system, e.g., via the bus 3105. The computing device may include a network interface 3114. The processor unit 3103 and network interface 3114 may be configured to implement a local area network (LAN) or personal area network (PAN), via a suitable network protocol, e.g., Bluetooth, for a PAN. The computing device may optionally include a mass storage device 3115 such as a disk drive, CD-ROM drive, tape drive, flash memory, or the like, and the mass storage device may store programs and/or data. The computing device may also include a user interface 3116 to facilitate interaction between the system and a user. The user interface may include a monitor, Television screen, speakers, headphones or other devices that communicate information to the user.

The computing device 3100 may include a network interface 3114 to facilitate communication via an electronic communications network 3120. The network interface 3114 may be configured to implement wired or wireless communication over local area networks and wide area networks such as the Internet. The device 3100 may send and receive data and/or requests for files via one or more message packets over the network 3120. Message packets sent over the network 3120 may temporarily be stored in a buffer in memory 3104. The categorized behavior database may be available through the network 3120 and stored partially in memory 3104 for use.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”. or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for training an intelligent agent, comprising:
a) creating a personality matrix;
b) combining a cognitive bias matrix with the personality matrix;
c) generating a behavioral function for a situation based on the combined cognitive bias matrix and personality matrix.

2. The method of claim 1 wherein the personality matrix includes at least parameters corresponding to the Meyers Briggs Type indicator.

3. The method of claim 1 wherein the personality matrix includes parameters corresponding to the Big Five personality traits.

4. The method of claim 1 wherein the personality matrix include at least one or more biographical parameters.

5. The method of claim 8 wherein the one or more biographical parameters include a locational, historical, cultural or educational parameter.

6. The method of claim 1 wherein the behavioral function is adapted from classified human interaction data and wherein the human interaction data is classified based on parameters of the personality matrix.

7. The method of claim 10 wherein the behavior function is generated by a neural network trained on the classified human interaction data and wherein the neural network training is modified by the personality matrix.

8. A method for using an intelligent agent, comprising:
a) determining a situation;
b) applying a behavioral function for the situation based on a combined cognitive bias matrix and personality matrix to generate a response to the situation.

9. The method of claim 8 wherein determining the situation includes using at least a neural network trained with natural language processing data.

10. The method of claim 9 wherein the natural language processing data includes at least one pre-answered response to a user question.

11. The method of claim 9 wherein the behavioral function modifies a response determined by the neural network.

12. The method of claim 8 wherein the personality matrix and the cognitive bias matrix includes at least a magnitude and a weight.

13. The method of claim 8 further comprising c) monitoring for an indication of success of the response.

14. The method of claim 13 wherein monitoring for an indication of success includes using machine vision or voice analysis to determine an emotional sentiment.

15. The method of claim 13 wherein monitoring for an indication of success includes monitoring the delay in response of a user, call back to the same topic, dismissiveness of the user or anger of the user.

16. The method of claim 13 further comprises using the indication of success of response to adjust the cognitive bias matrices or the personality matrices.

17. The method of claim 8 wherein determining the situation includes using visual information from machine vision or object recognition.

18. The method of claim 8 wherein the behavior function is applied by a neural network trained on classified human interaction data and wherein the neural network training is modified by the personality matrix.

19. An intelligent agent system, comprising:
a processor,
a memory coupled to the processor;
non-transient instructions embedded in the memory that when executed cause the processor to carry out the method comprising:
a) determining a situation;
b) applying a behavioral function for the situation based on a combined cognitive bias matrix and personality matrix to generate a response to the situation.

20. Non-transient instructions embedded in a computer readable medium that when executed cause a computer to implement the method comprising:
a) determining a situation;
b) applying a behavioral function for the situation based on a combined cognitive bias matrix and personality matrix to generate a response to the situation.
